(19) United States
(12) Patent Application Publication
(10) Pub. No.: US 2011/0282662 A1
(43) Pub. Date: Nov. 17, 2011

(54) Customer Service Data Recording Device, Customer Service Data Recording Method, and Recording Medium

(75) Inventors: Masashi Aonuma, Nagano-ken (JP); Junichi Yoshizawa, Nagano-ken (JP); Takashi Hama, Nagano-ken (JP); Tetsuo Ozawa, Nagano-ken (JP)

(73) Assignee: SEIKO EPSON CORPORATION, Tokyo (JP)

(21) Appl. No.: 13/092,450

(22) Filed: Apr. 22, 2011

(30) Foreign Application Priority Data
May 11, 2010 (JP) 2010-109036
May 11, 2010 (JP) 2010-109037

(51) Int. Cl. G10L 15/00

(52) U.S. Cl. 704/231; 704/E15.001

(57) ABSTRACT

To enable determining the correlation between customer satisfaction and employee satisfaction, a speech acquisition unit 102 acquires conversations between employees and customers; an emotion recognition unit 155 recognizes employee and customer emotions based on employee and customer speech in the conversation; a satisfaction calculator 156, 157 calculates employee satisfaction and customer satisfaction based on the emotion recognition output from the emotion recognition unit 155; and a customer service data recording unit 159 relates and records employee satisfaction data denoting employee satisfaction and customer satisfaction data denoting customer satisfaction as customer service data in a management server database DB.

### BACKGROUND

1. Technical Field

The present invention relates to a customer service data recording device that records customer service data in a database during customer service events, to a method of recording customer service data, and to a recording medium.

2. Related Art

Japanese Unexamined Patent Appl. Pub. JP-A-2004-252668 teaches a call center operator management system having a conversation input means that captures conversations between an operator and a customer in a call center, and an emotion recognition means that recognizes operator emotions from the operator speech contained in the captured conversation. This operator management system recognizes and outputs such operator emotions as fear and anger from the operator's voice, and informs the operator's manager when the output frequency reaches a preset threshold level.

The ability to measure and calculate customer satisfaction or employee satisfaction when providing customer service is desirable. In the customer service industry, customer satisfaction is known to greatly affect future sales, and employee satisfaction is known to greatly affect customer satisfaction. Customer satisfaction could be measured and used as customer service data (marketing data), or employee satisfaction could be measured and used instead of customer satisfaction as customer service data. This is achieved by calculating customer satisfaction or employee satisfaction based on the result of emotion recognition by the emotion recognition means.

However, customer satisfaction and employee satisfaction during the conversation do not necessarily correlate. For example, customer satisfaction could change for reasons unrelated to customer service and employee satisfaction, such as the price of the product or service, or the cleanliness of the store or restaurant, for example. A problem with JP-A-2004-252668 is that it cannot determine whether customer satisfaction changed as a result of customer service, or whether customer satisfaction changed for a reason other than customer service. More specifically, because the correlation between customer satisfaction and employee satisfaction cannot be determined, these values are deficient as customer service data.

In marketing, increasing customer satisfaction even if it means sacrificing some degree of productivity or efficiency is considered to ultimately be good by turning consumers into repeat customers. In addition, because there is a close relationship between sales and customer satisfaction in retail stores and the hospitality industry, training in customer service skills and how to smile and greet customers in order to make a good impression is used to improve overall customer satisfaction. Conversational techniques, which are one customer service skill, are particularly important, and customer service training focuses on the speaking ratio with the customer. In general, an employee-customer speaking ratio which a high customer percentage (such as 2:8) is preferable, and maintaining such a speaking ratio is said to favorably affect customer satisfaction.

However, while a speaking ratio that is good for customer service may be known, there is no method of measuring the speaking ratio, and whether individual employees achieve this speaking ratio is unknown. The effect of the speaking ratio on customer satisfaction is also not clear. As a result, even if training focuses on the speaking ratio and even if sales rise, there is no way to prove the correlation between the speaking ratio and increased sales.

Collecting information related to the actual speaking ratio and customer satisfaction during customer service events for use as marketing data in developing sales strategies is therefore desired in the retail industry, but has yet to be achieved.

### SUMMARY

The present invention provides a way to determine the correlation between customer satisfaction and employee satisfaction. The invention also provides a way to determine the correlation between the speaking ratio and customer satisfaction for use as marketing data.

A first aspect of the invention is a customer service data recording device including a conversation acquisition unit that acquires employee and customer conversations; an emotion recognition unit that recognizes employee and customer emotions based on employee and customer speech contained in the conversation; a satisfaction calculation unit that calculates employee satisfaction and customer satisfaction based on emotion recognition by the emotion recognition unit; and a customer service data recording unit that relates and records employee satisfaction data denoting employee satisfaction and customer satisfaction data denoting customer satisfaction as first customer service data in a database.

Another aspect of the invention is a customer service data recording method that records customer service data in a database based on employee and customer conversations, the recording method including as steps executed by a computer: a conversation acquisition step that acquires employee and customer conversations; an emotion recognition step that recognizes employee and customer emotions based on employee and customer speech contained in the conversation; a satisfaction calculation step that calculates employee satisfaction and customer satisfaction based on emotion recognition by the emotion recognition step; and a customer service data recording step that relates and records employee satisfaction data denoting employee satisfaction and customer satisfaction data denoting customer satisfaction as first customer service data in the database.

By recording employee satisfaction data denoting employee satisfaction related to customer satisfaction data denoting customer satisfaction as first customer service data, the correlation between employee satisfaction and customer satisfaction can be inferred from the customer service data. Whether or not customer satisfaction changed due to factors associated with employee satisfaction can therefore be determined. Furthermore, because change in employee satisfaction can be inferred from customer satisfaction, and change in customer satisfaction can be inferred from employee satisfaction, whether or not customer satisfaction and employee satisfaction are accurately calculated can be determined, and the reliability of the calculated customer satisfaction and employee satisfaction can be compensated for.

In a customer service data recording device according to another aspect of the invention, the customer service data recording unit preferably also has a customer service period identification unit that identifies customer service periods where one customer service period is defined as a conversation between an employee and a customer that continues without an interruption exceeding a specified time; and the customer service data recording unit records employee satisfaction data and customer satisfaction data for each customer service period.

In a customer service data recording method according to another aspect of the invention, the computer preferably also executes: a customer service period identification step that identifies customer service periods where one customer service period is defined as a conversation between an employee and a customer that continues without an interruption exceeding a specified time; and in the customer service data recording step records employee satisfaction data and customer satisfaction data for each customer service period.

Because employee satisfaction data and customer satisfaction data is recorded for each customer service period in these aspects of the invention, the correlation between employee satisfaction and customer satisfaction can be determined by customer service period unit.

In a customer service data recording device according to another aspect of the invention, the customer service data recording unit preferably stores either or both the start time and the end time of the customer service period together with the employee satisfaction data and the customer satisfaction data.

In a customer service data recording method according to another aspect of the invention, the customer service data recording step preferably stores either or both the start time and the end time of the customer service period together with the employee satisfaction data and the customer satisfaction data.

By relating and recording the start time and the end time of the customer service period, the recording time and length of the employee satisfaction data and customer satisfaction data can be determined.

A customer service data recording device according to another aspect of the invention, preferably also has an identification unit that identifies employees and customers, and the customer service data recording unit records employee identification information identifying the employee and customer identification information identifying the customer related to the employee satisfaction data and the customer satisfaction data.

By thus recording employee identification information and customer identification information related to the employee satisfaction data and customer satisfaction data, the recorded customer service data can be related to a specific conversation between a particular employee and a particular customer.

Further preferably, the customer service data recording unit stores sales results indicating the result of customer service provided by the employee to the customer together with the employee satisfaction data and the customer satisfaction data.

By recording sales results related to the employee satisfaction data and customer satisfaction data, the correlation between employee satisfaction and customer satisfaction and sales can be determined.

Further preferably, the customer service data recording unit stores audio data of the recorded conversation and video data of the employee serving the customer together with the employee satisfaction data and the customer satisfaction data.

By thus recording audio data from conversations and video data of customer service events together with the employee satisfaction data and the customer satisfaction data, the content of the conversation and customer service that resulted in the recorded employee satisfaction data and customer satisfaction data can be determined.

A customer service data recording device according to another aspect of the invention preferably also has an audio playback unit that reproduces the audio data; a progress bar display unit that displays a progress bar indicating the progress of audio playback; and a speech period identification unit that identifies the speech periods where one speech period is a set of consecutive employee or customer utterance periods that continue without an interruption exceeding a specified time, and one utterance period is a period of continuous vocalization. The progress bar display unit displays the progress bar to differentiate the employee speech periods and the customer speech periods identified by the speech period identification unit.

This aspect of the invention enables checking the employee-customer speaking ratio and the interval between speaking because periods of employee speech and periods of customer speech in a conversation can be seen.

Further preferably, the customer service data recording device preferably has a screen display unit that displays a window based on customer service data. This aspect of the invention enables viewing the recorded customer service data in a window on screen.

Further preferably, the conversation acquisition unit also acquires conversations between an employee and an employee supervisor, and conversations between an employee and a peer, and an evaluation unit that determines the category of the person conversing with the employee, that is, whether the other person is a customer, supervisor, or peer. In addition, the screen display unit preferably displays the employee satisfaction data linked to the detected category of the other person.

By determining the category of the other person in a conversation and recording this information linked to the employee satisfaction data, this aspect of the invention enables knowing the category of person the employee was speaking with in the conversation from which the employee satisfaction data was derived.

The customer service data recording unit according to another aspect of the invention preferably also has a speech period extraction unit that extracts employee speech periods and customer speech periods from the acquired conversation, the employee speech periods being vocalization periods resulting from employee speech and the customer speech periods being vocalization periods resulting from customer speech; and a speaking ratio calculation unit that calculates a speaking ratio as a ratio of the length of the employee speech period and the length of the customer speech period, or as a ratio of the length of the employee speech period or customer speech period to the total length of the employee speech period and the customer speech period. The emotion recognition unit recognizes customer emotion based on speech in the customer speech period; and the customer service data recording unit records speaking ratio data based on the calculated speaking ratio related to satisfaction data based on customer satisfaction as second customer service data in a database.

In a customer service data recording method according to another aspect of the invention, the computer preferably also executes: a speech period extraction step that extracts employee speech periods and customer speech periods from the acquired conversation, the employee speech periods being vocalization periods resulting from employee speech and the customer speech periods being vocalization periods resulting from customer speech; and a speaking ratio calculation step that calculates a speaking ratio as a ratio of the length of the employee speech period and the length of the customer speech period, or as a ratio of the length of the employee speech period or customer speech period to the total length of the employee speech period and the customer speech period; recognizes customer emotion based on speech in the customer speech period in the emotion recognition step; and records speaking ratio data based on the calculated speaking ratio related to satisfaction data based on customer satisfaction as second customer service data in a database in the customer service data recording step.

By recording second customer service data relating speaking ratio data and satisfaction data, the second customer service data can be used as marketing data. In addition, the effect of the speaking ratio on customer satisfaction can be inferred from the second customer service data, and used to demonstrate the effectiveness of conversation training. Furthermore, because the invention can also be used by individuals, this information can be used to improve one's own conversational skills (conversational technique).

If the length of the employee speech period is La and the length of the customer speech period is Lb, the speaking ratio can be expressed as (1) a ratio between La and Lb, or (2) a ratio of La or Lb to (La+Lb).

Note that employee and customer speech does not need to be acquired from a single conversation acquisition unit (such as a microphone), and can be separately acquired using two conversation acquisition units. In this case, the speech period extraction unit can different employee and customer speech and extract the speech periods based on the conversation acquisition unit that captured the speech.

Further preferably, the customer service data recording device according to another aspect of the invention also has an utterance detection unit that is attached to the employee and detects employee utterances; and the speech period extraction unit determines if speech contained in the conversation is employee speech or customer speech, and extracts the speech periods based on the result of this determination, based on the detection result from the utterance detection unit.

Yet further preferably in a customer service data recording method according to another aspect of the invention, the computer also executes an utterance detection step that is attached to the employee and detects employee utterances; and in the speech period extraction step, determines if speech contained in the conversation is employee speech or customer speech based on the detection result from the utterance detection step, and extracts the speech periods based on the result of this determination.

By using an utterance detection unit, this aspect of the invention can accurately identify employee and customer speech, and can thereby more accurately calculate the speaking ratio and customer satisfaction.

An example of an utterance detection unit is a bone conduction sensor that detects bone-conducted sounds such as a person's voice conducted through bone and other tissues. In this case the bone conduction sensor is preferably worn on the head.

Yet further preferably, when a vocalization period that continues without inhaling is one utterance period, and a set of employee or customer utterance periods that continue without an interruption exceeding a specified time is one speech period, the speaking ratio calculation unit calculates the length of each speech period as the total length of all utterance periods contained in one speech period.

This aspect of the invention enables calculating the speaking ratio based on the total length of employee and customer utterance periods. More specifically, when an utterance period is interrupted by breathing (taking a breath), the length of the employee speech periods and the length of customer speech periods minus such intervals can be determined.

Further preferably, in a customer service data recording device according to another aspect of the invention, when a set of employee and customer speech periods that alternate without an interruption exceeding a specified time therebetween is one conversation period, the speaking ratio calculation unit calculates the speaking ratio in each conversation period based on one or more speech periods contained in the conversation period, and the satisfaction calculation unit calculates customer satisfaction in each conversation period based on customer satisfaction in each customer speech period in the conversation period.

This aspect of the invention calculates the speaking ratio for each conversation period, which is a group of consecutive speech periods, and can calculate a more reliable speaking ratio than when the speaking ratio is calculated by unit time. Furthermore, because customer satisfaction is calculated in the same period as the speaking ratio, the correlation therebetween can be more accurately determined.

In a customer service data recording device according to another aspect of the invention, the emotion recognition unit applies emotion recognition by utterance period unit; and the satisfaction calculation unit calculates customer satisfaction by utterance period unit, and calculates customer satisfaction in the customer speech period as the average of customer satisfaction in each utterance period in the customer speech period.

By applying emotion recognition in utterance period units, this aspect of the invention enables more accurate emotion recognition compared with configurations that apply emotion recognition to speech period or conversation period units.

In another aspect of the invention, when a group of conversation periods that continue without an interruption exceeding a specified time is extracted as one customer service period, the speaking ratio calculation unit calculates the average speaking ratio of all conversation periods in the customer service period as the speaking ratio in that customer service period, the satisfaction calculation unit calculates the average customer satisfaction in all conversation periods in the customer service period as the customer satisfaction in the customer service period, and the customer service data recording unit records the speaking ratio in the customer service period and the speaking ratio in each conversation period as speaking ratio data, and records customer satisfaction in the customer service period and customer satisfaction in each conversation period as the satisfaction data.

By recording the speaking ratio in each conversation period as the speaking ratio data, and recording the customer satisfaction in each conversation period as satisfaction data, this aspect of the invention enables checking change in the conversation and change in customer emotion during a single customer service event from the customer service data. In addition, customer service can be easily evaluated comprehensively by recording customer satisfaction and the speaking ratio in each customer service period as customer service data.

A customer service data recording device according to another aspect of the invention preferably also has a screen display unit that displays a screen for viewing the second customer service data. The screen display unit extracts and displays on the viewing screen customer service data containing person identification information matching the selected or input person identification information identifying a employee and/or customer.

By selecting or inputting person identification information identifying at least one of an employee or a customer as a search condition, this aspect of the invention enables viewing the desired customer service data on screen.

Further preferably, the screen display unit displays an overlay graph showing the change in the speaking ratio during each conversation period in the customer service period, and the change in customer satisfaction in the conversation period, on the same time base on screen. As a result, the correlation between change in the conversation and change in customer emotion during one customer service event can be easily determined from the same display.

Another aspect of the invention is a recording medium that is computer-readable recording medium and records a program causing a computer to execute the steps of the customer service data recording method described above.

This aspect of the invention enables executing the steps of the customer service data recording method described above as by simply causing the computer to read the recording medium.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the configuration of a customer service support system according to a first embodiment of the invention.

FIG. 2 is a control block diagram of an employee terminal.

FIG. 3 is a control block diagram of a receipt printer.

FIG. 4 is a control block diagram of a management server.

FIG. 5 describes an utterance period, a speech period, a conversation period, and a customer service period.

FIG. 6 is a function block diagram of a customer service support system according to the first embodiment of the invention.

FIG. 7 describes the structure of a management server database in the first embodiment of the invention.

FIG. 8 shows examples of speech data management table, an employee utterance period management table, and a customer utterance period management table.

FIG. 9 is a flow chart showing a speech data storage process according to the first embodiment of the invention.

FIG. 10 is a flow chart showing a customer service period identification process according to the first embodiment of the invention.

FIG. 11 is a flow chart showing an employee speech period identification process according to the first embodiment of the invention.

FIG. 12 is a flow chart showing a customer speech period B identification process according to the first embodiment of the invention.

FIG. 13 is a flow chart showing a customer speech period A identification process according to the first embodiment of the invention.

FIG. 14 is a flow chart showing a satisfaction recording process.

FIG. 15 shows a first window according to the first embodiment of the invention.

FIG. 16 shows a second window according to the first embodiment of the invention.

FIG. 17 is a function block diagram of a customer service support system according to a second embodiment of the invention.

FIG. 18 shows a first window according to the second embodiment of the invention.

FIG. 19 shows a second window according to the second embodiment of the invention.

FIG. 20 is a function block diagram of a customer service support system according to a third embodiment of the invention.

FIG. 21 describes the structure of a management server database according to the third embodiment of the invention.

FIG. 22 describes an algorithm for calculating a speaking ratio.

FIG. 23 shows a method of measuring the number of speech overlaps.

FIG. 24 shows an example of a window (showing a speaking ratio table).

FIG. 25 shows an example of a window (showing a speaking ratio-sales correlation chart).

FIG. 26 shows an algorithm for calculating customer service scores, a speaking ratio evaluation table, and a speech overlap evaluation table.

FIG. 27 is a function block diagram of a customer service support system according to a fourth embodiment of the invention.

FIG. 28 shows an example of a management server database according to the fourth embodiment of the invention.

FIG. 29 describes an algorithm for calculating customer satisfaction.

FIG. 30 shows an example of a window (showing a satisfaction-speaking ratio table).

FIG. 31 shows an example of a window (showing a satisfaction-speaking ratio correlation graph).

FIG. 32 is a function block diagram of a customer service support system according to a fifth embodiment of the invention.

FIG. 33 shows an example of a management server database according to the fifth embodiment of the invention.

FIG. 34 shows an example of change detection data and different-customer service periods.

FIG. 35 shows an example of the results of identifying customer service conversation periods, and the corresponding customer service conversation periods.

FIG. 36 describes customer service period identification pattern A.

FIG. 37 describes customer service period identification pattern B.

FIG. 38 describes customer service period identification pattern C.

FIG. 39 describes setting a customer service period.

### DESCRIPTION OF EMBODIMENTS

### Embodiment 1

A preferred embodiment of a customer service data recording device, a customer service data recording method, and a recording medium is described below with reference to the accompanying figures. The following preferred embodiments describe a customer service data recording device according to the invention used in a customer service support system SY.

This customer service support system SY is designed to recognize employee and customer emotions at the point-of-service in stores and other venues in the retail, restaurant, and service industries, and apply the results to improve both employee satisfaction (worker satisfaction) and customer satisfaction, as well as sales. This embodiment of the invention therefore describes recognizing employee and customer emotions during a customer service event in a retail clothing store.

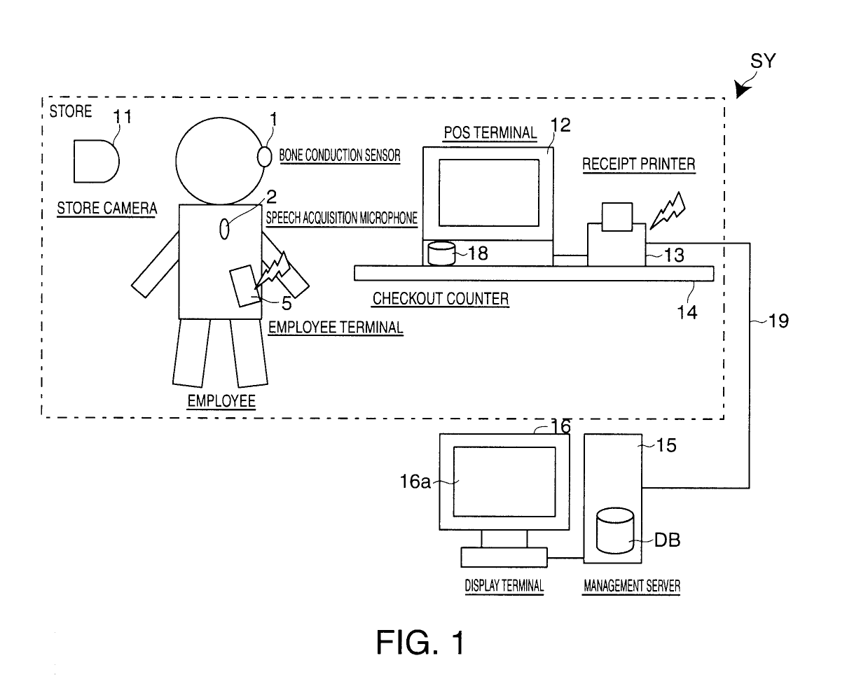

FIG. 1 shows the configuration of a customer service support system SY according to the first embodiment of the invention. As shown in the figure, the customer service support system SY includes a bone conduction sensor 1, speech acquisition microphone 2, and employee terminal 5 that are worn or carried by the employee, store cameras 11 (only one shown in the figure) that are installed at the store entrance and other locations throughout the store, a POS (point-of-sale) terminal 12 and receipt printer 13 installed at the checkout counter 14, and a management server 15 and display terminal 16 located in the back office of the store. Note that a computer is rendered by the control system of the various devices in this customer service support system SY.

The bone conduction sensor 1 is worn on the employee's head and detects the employee's voice conducted through bone and muscle to the body surface. In this embodiment of the invention the bone conduction sensor 1 is used to determine whether audio picked up by the speech acquisition microphone 2 was voiced by the employee or the customer.

The speech acquisition microphone 2 is attached to the employee's clothing near the chest, and captures both employee and customer speech. Alternatively, directional microphones for the employee and customer could be used instead of the bone conduction sensor 1 and speech acquisition microphone 2. More specifically, two microphones could be used to acquire employee speech and customer speech, and employee speech and customer speech could be differentiated according to the microphone from which the speech was acquired.

The employee terminal 5 is attached to the employee's clothing, such as a belt, and acquires the output data of the bone conduction sensor 1 and speech acquisition microphone 2 through a dedicated cable. The employee terminal 5 can also communicate with the receipt printer 13 wirelessly, and communicates information with the management server 15 through the receipt printer 13.

The store camera 11 is disposed to the ceiling, for example, at different locations throughout the store, and captures images of customers coming to the store and interactions between the customers and employees. The store camera 11 may be a CCD camera or a PTZ (pan-tilt-zoom) camera, for example.

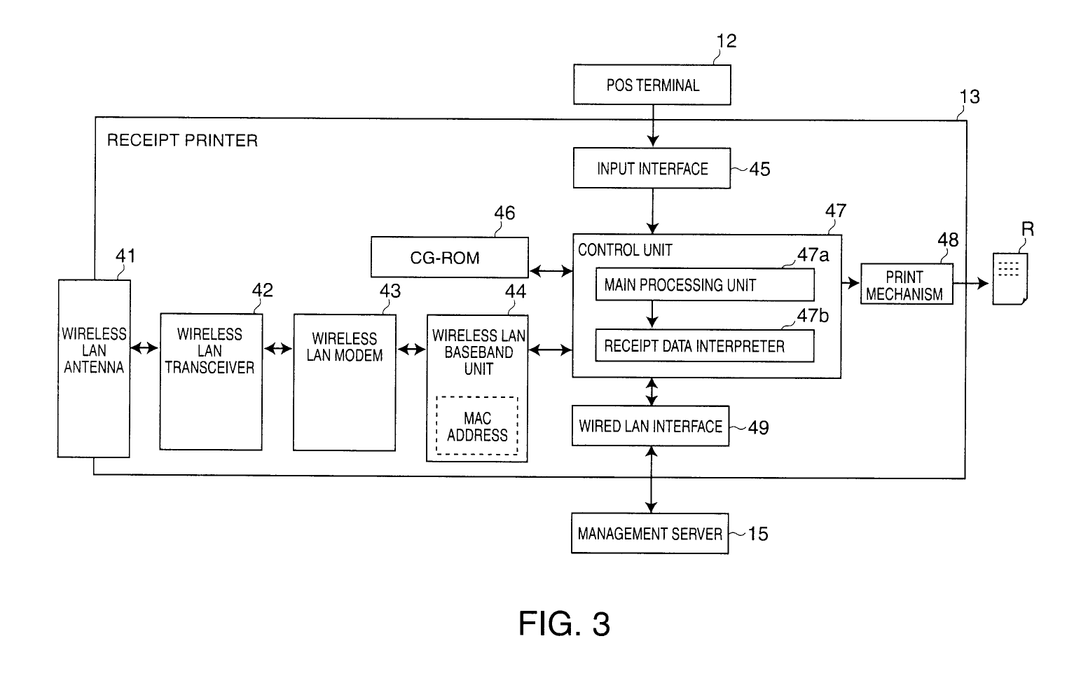

The POS terminal 12 is configured like a typical cash register, and runs a transaction process according to a POS application. The POS terminal 12 also gets product codes from a barcode scanner or keyboard not shown, and references a product master 18 to generate receipt data for printing a sales receipt R (FIG. 3).

The receipt printer 13 is connected to the POS terminal 12 through a dedicated cable, and prints the receipt print data acquired from the POS terminal 12 on receipt paper. The receipt printer 13 can also communicate wirelessly with the employee terminal 5, and communicate by wire with the management server 15. By inputting and outputting information through the receipt printer 13 (the receipt printer 13 filtering data input thereto and outputting the necessary information), communication with the employee terminal 5 and management server 15 is prevented from affecting traffic on the main POS network (the network for the POS terminals 12). The invention can also be used with existing POS systems without needing to change the main POS network.

The management server 15 is connected to the receipt printer 13 through an intranet or other network 19, and receives information from the employee terminal 5 through the receipt printer 13. Based on audio data and other data acquired from the employee terminal 5, the management server 15 also recognizes speech, recognizes emotions, and calculates satisfaction (employee satisfaction and customer satisfaction).

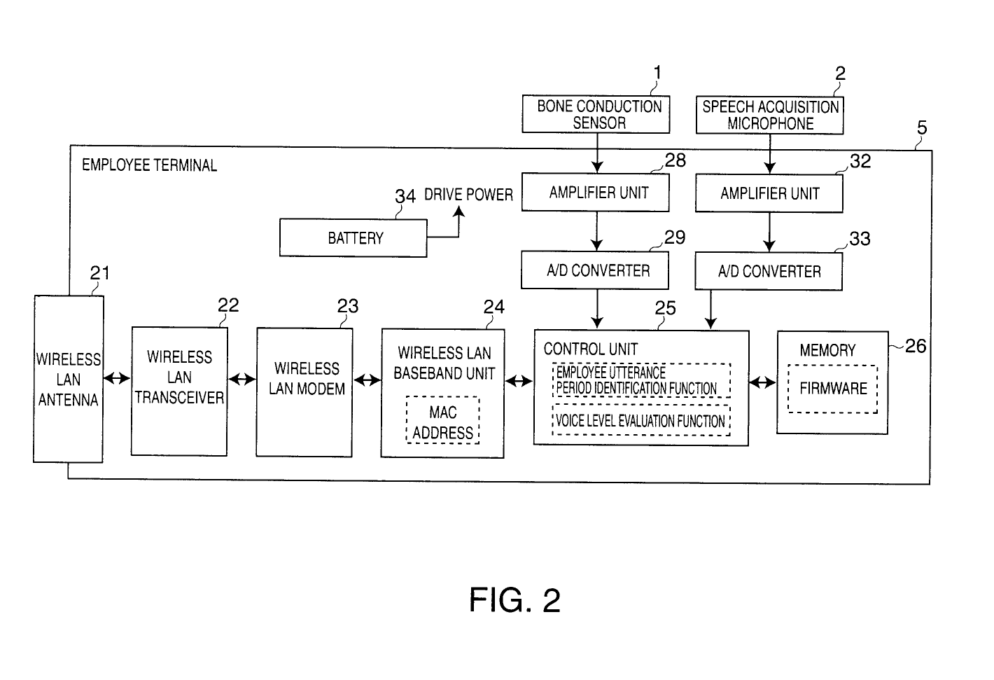

The hardware configuration of the employee terminal 5, the receipt printer 13, and the management server 15 are described next with reference to FIG. 2 to FIG. 4.

FIG. 2 is a control block diagram of the employee terminal 5. The employee terminal 5 has a wireless LAN antenna 21, a wireless LAN transceiver 22, a wireless LAN modem 23, and a wireless LAN baseband unit 24 enabling wireless communication with the receipt printer 13. The wireless LAN baseband unit 24 stores a MAC address identifying the employee terminal 5.

The employee terminal 5 also has an amplifier unit 28 and A/D converter 29 for acquiring detection results from the bone conduction sensor 1, and a amplifier unit 32 and A/D converter 33 for acquiring audio data captured by the speech acquisition microphone 2.

The employee terminal 5 also has a control unit 25 that controls other parts, memory 26 that stores firmware and data, and a battery 34 that supplies power. The control unit 25 has an employee utterance period identification function that identifies the employee utterance period (a period of continuous vocalization) based on data acquired from A/D converter 29 and A/D converter 33, and a voice level evaluation function that determines the voice level (volume of speech) based on data acquired from A/D converter 33.

FIG. 3 is a control block diagram of the receipt printer 13. The receipt printer 13 has a wireless LAN antenna 41, a wireless LAN transceiver 42, a wireless LAN modem 43, and a wireless LAN baseband unit 44 enabling wireless communication with the employee terminal 5. The wireless LAN baseband unit 44 stores a MAC address identifying the receipt printer 13.

The receipt printer 13 also has an input interface 45 through which receipt data from the POS terminal 12 is input, a CG-ROM 46 storing character patterns, a control unit 47 that controls other parts, a print mechanism 48 including a printhead, head drive mechanism, and receipt paper transportation mechanism, and a wired LAN interface 49 connected to the management server 15 through a wired LAN.

The control unit 47 includes a main processing unit 47a that interprets receipt data including specific commands and generates print data for printing a sales receipt R, and a receipt data interpreter 47b, which is specific to this embodiment of the invention.

The receipt data interpreter 47b recognizes the device number of the POS terminal 12, receipt number, product codes, product names, unit product prices, sales total, operator name, and other information from the receipt data, and converts the recognized data to a specific data format (such as XML) that can be interpreted by the management server 15, which is the host system. Note that the result of converting the recognized receipt data to the specific data format is referred to as the “converted data” below.

The control unit 47 sends the speech data received from the employee terminal 5 through the wireless LAN (the speech data acquired from the wireless LAN baseband unit 44) through the wired LAN interface 49 to the management server 15.

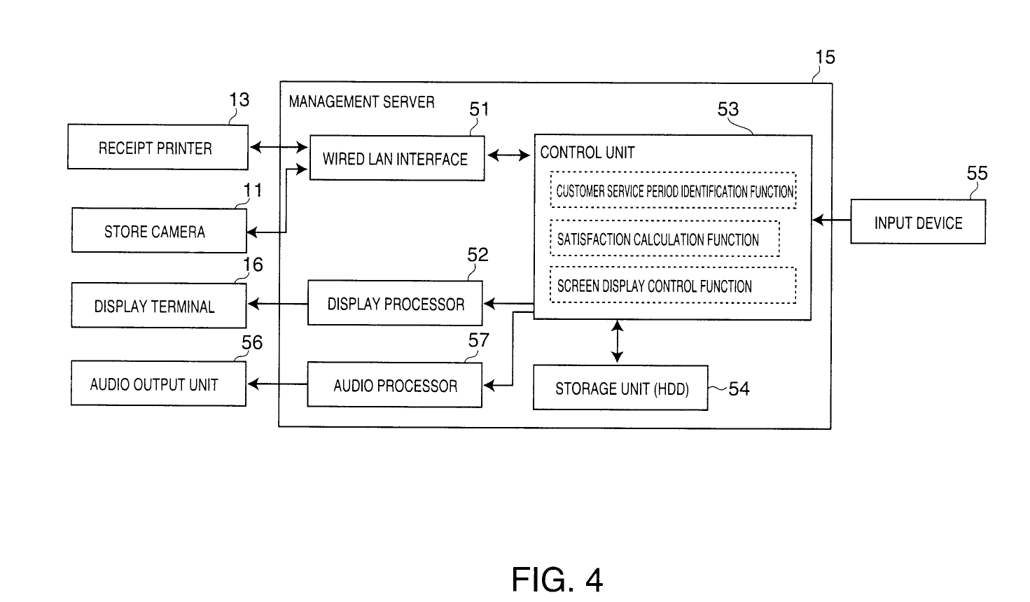

FIG. 4 is a control block diagram of the management server 15. The management server 15 includes a wired LAN interface 51 for acquiring speech data and converted data from the receipt printer 13 and video data from the store camera 11; a display processor 52 for displaying information on the display terminal 16; an audio processor 57 for outputting audio to an audio output unit 56; a control unit 53 for acquiring input data from an input device 55 such a mouse or keyboard and control other parts of the management server 15; and a storage unit 54 that stores information.

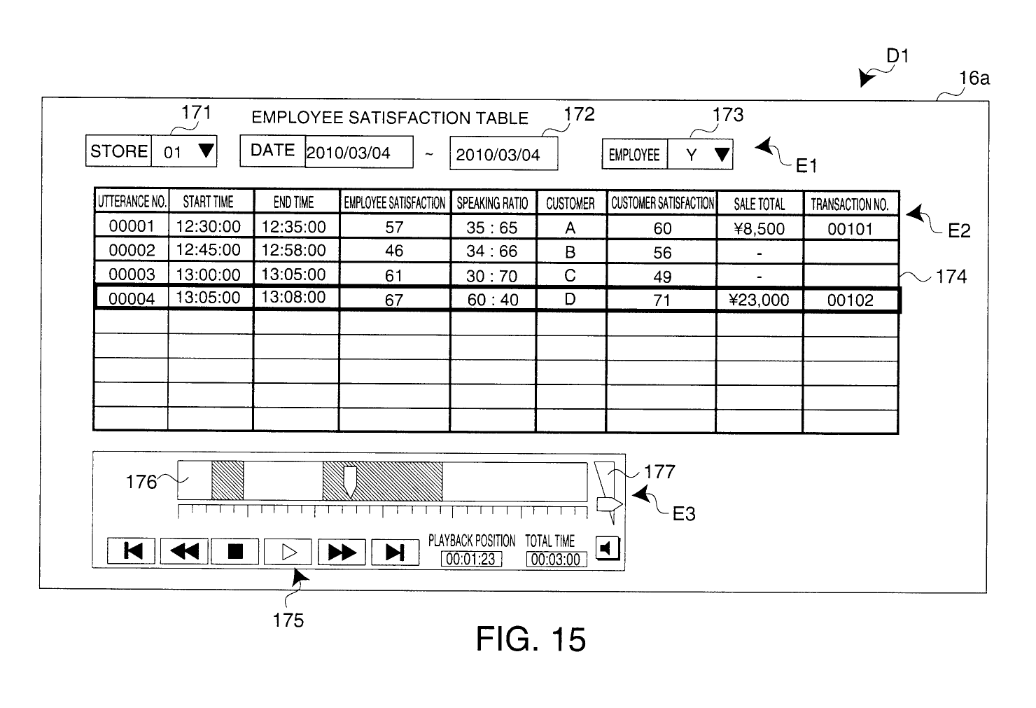

The control unit 53 has a customer service period identification function that identifies the customer service period (a period of sustained conversation between the employee and a customer), and a satisfaction calculation function that calculates employee satisfaction and customer satisfaction, based on the acquired speech data. The control unit 53 also has a screen display control function that controls displaying information in the window D (FIG. 15) where the calculated degrees of satisfaction are displayed.

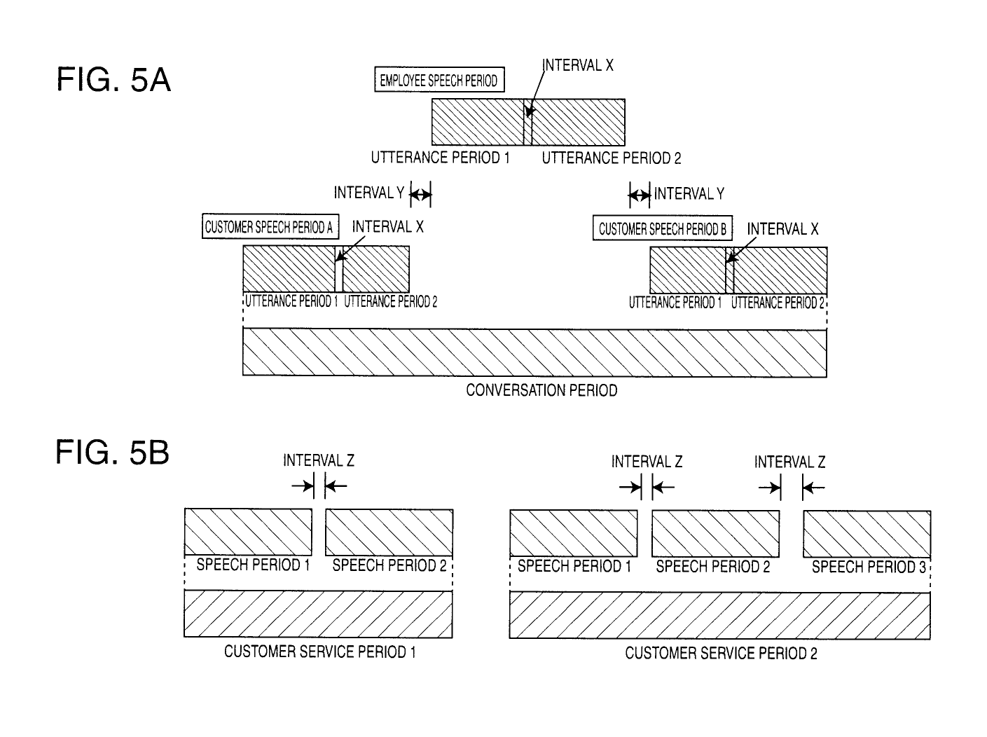

The periods used in this embodiment of the invention are described next with reference to FIG. 5.

An utterance period is a period of continuous vocalization by the same person, and is typically a period in which one phrase uninterrupted by taking a breath (breathing) is voiced. Emotion recognition and speech recognition are done in utterance period units in this embodiment of the invention.

As shown in FIG. 5 (a), a speech period is a set of employee or customer utterance periods continuing without an interruption exceeding a specified time. More specifically, a speech period is a set of one or more utterance periods where the interval therebetween is less than a specified time X (where X is a constant and X>0). In the example shown in the figure, the speech period of the employee (“employee speech period” herein) and the two speech periods of a customer (“customer speech periods” herein) before and after the employee speech period are each composed of two utterance periods.

As shown in FIG. 5 (a), a conversation period is a set of alternating employee and customer speech periods that continue without an interruption exceeding a specified time. More specifically, a conversation period is a set of one or more utterance periods where the interval therebetween is less than a specified time Y (where Y is a constant and Y>X). Note that in this embodiment of the invention a set including an employee speech period and before and after customer speech periods (that is, a set including a minimum of two and a maximum of three speech periods) is defined as “one conversation pattern” (=one conversation period).

As shown in FIG. 5 (b), a customer service period is a set of conversation periods that continue without an interruption exceeding a specified time. More specifically, a customer service period is a set of one or more conversation periods where the interval therebetween is less than a specified time Z (where Z is a constant and Z>Y). The example in the figure shows a first customer service period composed of two conversation periods, and a second customer service period composed of three conversation periods. A customer service period may thus contain any desired number of conversation periods.

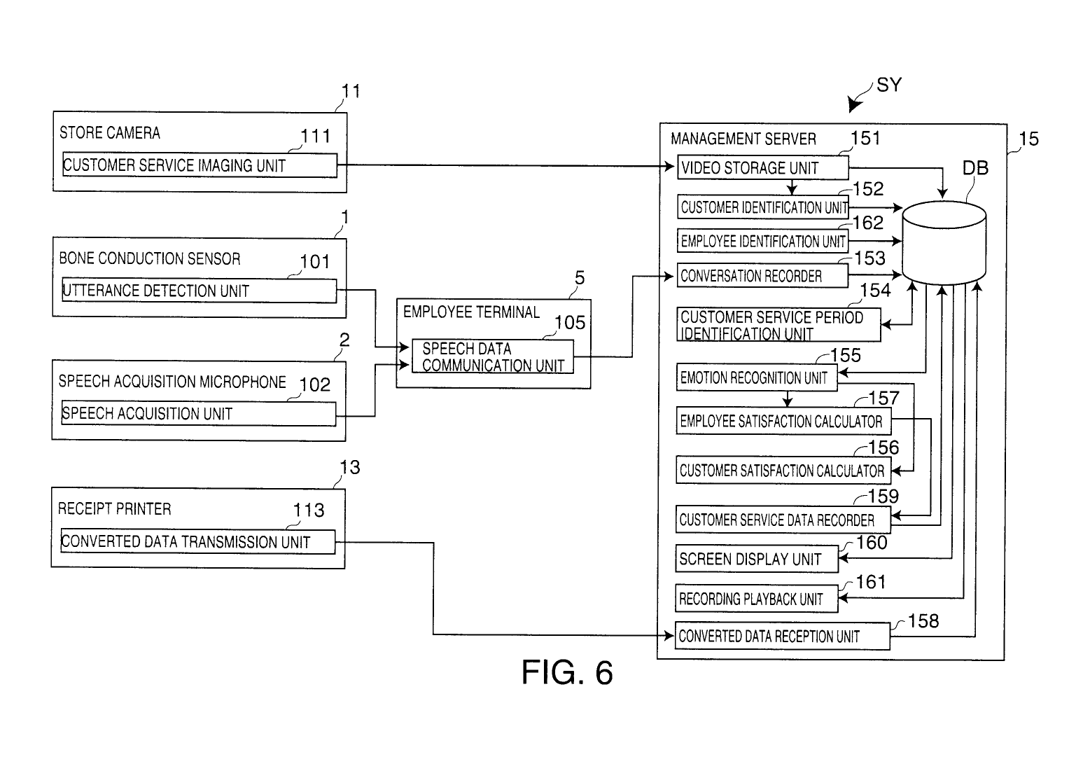

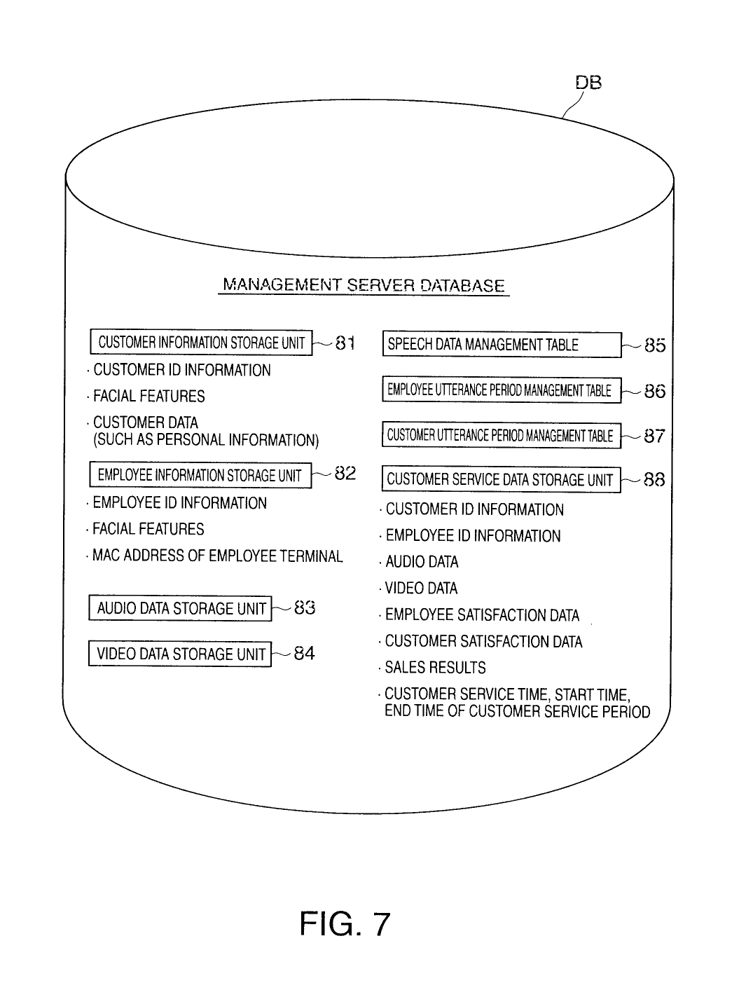

The functional configuration of the customer service support system SY according to the first embodiment of the invention is described next with reference to FIG. 6 and FIG. 7. FIG. 6 is a block diagram of the customer service support system SY.

The main functional unit of the store camera 11 is the customer service imaging unit 111. The customer service imaging unit 111 records customer service events between employees and customers. In this embodiment of the invention the customer service imaging unit 111 is always recording, and outputs the captured video data continuously to the management server 15.

The main functional unit of the bone conduction sensor 1 is an utterance detection unit 101. The utterance detection unit 101 detects that the employee said something and the utterance period based on bone conducted sound.

The main functional unit of the speech acquisition microphone 2 is a speech acquisition unit 102 (conversation acquisition unit). The speech acquisition unit 102 captures employee and customer speech (audio signals).

The main functional unit of the employee terminal 5 is a speech data communication unit 105. The speech data communication unit 105 detects speech using a power filter in the voice level evaluation function, and sends speech data greater than or equal to a preset sound level (such as at least 1.5 V after amplification) to the management server 15. Using an employee utterance period identification function, the speech data communication unit 105 also identifies the employee utterance period based on the detection result from the utterance detection unit 101 and the speech acquired by the speech acquisition unit 102, and reports the occurrence of an employee utterance period to the management server 15.

Note that the employee terminal 5 and management server 15 actually communicate through the receipt printer 13, but the receipt printer 13 is omitted from the figure because information only passes therethrough.

The main functional unit of the receipt printer 13 is a converted data transmission unit 113. The converted data transmission unit 113 sends the converted data obtained by converting the receipt data output from the POS terminal 12 to XML as described above to the management server 15.

The main functional units of the management server 15 include a video storage unit 151, customer identification unit 152, employee identification unit 162, conversation recorder 153, customer service period identification unit 154, emotion recognition unit 155, employee satisfaction calculator 157, customer satisfaction calculator 156, customer service data recorder 159, screen display unit 160, recording playback unit 161, converted data reception unit 158, and management server database DB.

Note that the customer service period identification unit and speech period identification unit in the accompanying claims are rendered by the customer service period identification unit 154; a screen display unit and progress bar display unit are rendered by the screen display unit 160; a satisfaction calculator is rendered by employee satisfaction calculator 157 and customer satisfaction calculator 156; and an identification unit is rendered by the customer identification unit 152 and employee identification unit 162.

The video storage unit 151 acquires video data from the customer service imaging unit 111, and records the video data in the management server database DB.

The customer identification unit 152 identifies a customer based on the facial features contained in the video data. More specifically, customer identification information and the facial features of customers are stored in the management server database DB (see the customer information storage unit 81 in FIG. 7). The customer identification unit 152 compares the facial features of the imaged customer (analyzes the image output of the store camera 11 to detect a face, and extracts the facial features by normalizing the image in the extracted face) with the facial features of a plurality of customers stored in the management server database DB, and identifies the customer based on the greatest similarity of facial features.

The employee identification unit 162 acquires the MAC address of the employee terminal 5, and identifies the employee from the employee identification information associated with the MAC address. More specifically, MAC addresses and employee identification information (such as an employee ID) are linked together in the management server database DB (see the employee information storage unit 82 in FIG. 7), and an employee can be identified by referencing the MAC address of the employee terminal 5. Employees could also be identified from facial features contained in the video data. More specifically, employee identification information and facial features can be previously stored in the management server database DB, the facial features of the employee extracted from the video data compared with the facial features of all employees stored in the management server database DB, and the employee with the greatest similarity to the facial features extracted from the video data identified as the employee that is serving the customer.

The conversation recorder 153 records conversations between employees and customers, or more specifically the speech data sent from the speech data communication unit 105, in the management server database DB.

Based on the results output by the utterance detection unit 101 (that is, the employee utterance periods identified by the speech data communication unit 105), the customer service period identification unit 154 determines whether the voices in the conversation are the voice of the employee or the voice of the customer, and identifies the speech periods, conversation periods, and customer service periods.

The emotion recognition unit 155 recognizes employee emotions based on employee speech contained in the conversation, and recognizes customer emotions based on customer speech contained in the conversation.

More specifically, emotions are recognized based on such factors as change in vocal strength, the speed of speech (the number of mora per unit time), the strength of individual words, volume, and change in the speech spectrum. In this embodiment of the invention the emotion recognition unit 155 applies emotion recognition to each utterance period (each employee utterance period or each customer utterance period) identified by the customer service period identification unit 154. Accurate emotion data can thus be acquired by applying emotion recognition phrase by phrase.

Speech overlaps where a customer utterance period and an employee utterance period overlap on the time base are also identified, these speech overlap periods are treated as emotion recognition exception periods to which emotion recognition is not applied, and emotion recognition is applied to the customer utterance period except in the speech overlap period. Recognition errors can be prevented by applying emotion recognition except in the emotion recognition except ion periods where customer speech and employee speech overlap and accurate emotion recognition is not possible.

employee satisfaction calculator 157 calculates employee satisfaction based on the result of emotion recognition applied to the employee's speech by the emotion recognition unit 155. As the emotion recognition unit 155 applies emotion recognition to each utterance period, employee satisfaction calculator 157 also calculates employee satisfaction for each utterance period (more precisely, each employee utterance period).

The customer satisfaction calculator 156 calculates customer satisfaction based on the result of emotion recognition applied to the customer's speech by the emotion recognition unit 155. Customer satisfaction is calculated as described in further detail below. employee satisfaction calculator 157 likewise calculates customer satisfaction for each utterance period (more precisely, each customer utterance period).

At the end of each customer service period, the customer service data recorder 159 records the first customer service data in the management server database DB. This customer service data includes the customer identification information determined by the customer identification unit 152, the employee identification information output from the employee identification unit 162, employee satisfaction data calculated by employee satisfaction calculator 157, and customer satisfaction data calculated by customer satisfaction calculator 156.

The converted data reception unit 158 receives and records the converted data sent from the converted data transmission unit 113 in the management server database DB. Note that this converted data is used to get information related to the sales results that are also recorded as customer service data. It is therefore possible to extract from the information contained in the converted data and record as the sales result data only the information that enables identifying whether or not a sale was made and the sale total, such as the receipt number and the sale total. Alternatively, all of the converted data could be recorded in the management server database DB.

The screen display unit 160 presents window D (see FIG. 15) on the display screen 16a of the display terminal 16 based on the recorded customer service data. This window D is described below in detail.

The recording playback unit 161 reproduces the recorded audio data from the audio output unit 56 according to instructions input from the window D.

FIG. 7 describes the structure of the management server database DB in the first embodiment of the invention. The management server database DB functions as a customer information storage unit 81, employee information storage unit 82, audio data storage unit 83, video data storage unit 84, speech data management table 85, employee utterance period management table 86, customer utterance period management table 87, and customer service data storage unit 88. Note that the management server database DB may be rendered separately for each store, or could centrally manage data from a plurality of stores.

The customer information storage unit 81 stores customer identification information (such as a customer ID) related to the facial features of the customer and other customer data (personal information such as name, address, telephone number, date of birth, sex).

The employee information storage unit 82 records employee identification information (such as an employee ID) related to the facial features of the employee and the MAC address of the employee terminal 5.

The audio data storage unit 83 stores the audio data that is continuously recorded by the conversation recorder 153.

The video data storage unit 84 records the video data that is continuously captured by the customer service imaging unit 111.

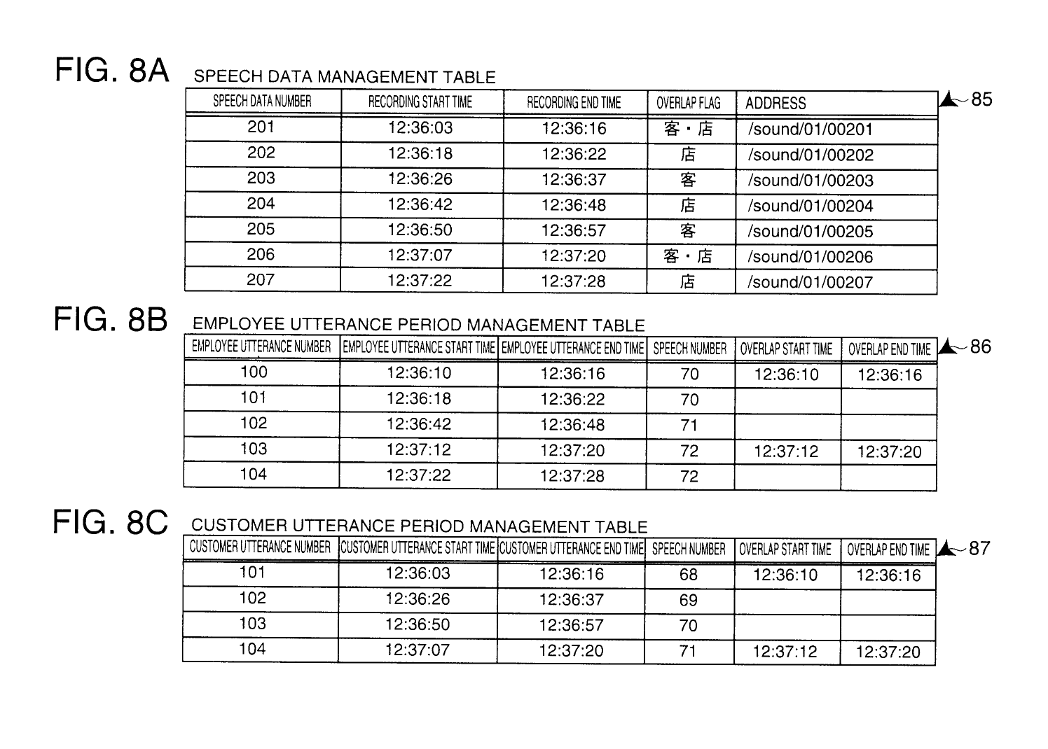

The speech data management table 85 records acquired speech data for each period of continuous speech (“continuous utterance periods” below) without differentiating between employee and customer as shown in FIG. 8 (a).

The employee utterance period management table 86 records employee utterance periods as shown in FIG. 8 (b).

The customer utterance period management table 87 records customer utterance periods as shown in FIG. 8 (c).

The customer service data storage unit 88 stores the customer service data noted above.

The speech data management table 85, employee utterance period management table 86, and customer utterance period management table 87 are described next with reference to FIG. 8.

FIG. 8 (a) shows an example of a speech data management table 85.

The speech data management table 85 stores a speech data number assigned to each contiguous utterance period (a period containing at least one utterance period), which is a period of continuous speech not differentiating between employee and customer speech; a recording start time denoting the time when the contiguous utterance period started; a recording end time denoting the time when the contiguous utterance period ended; an overlap flag denoting whether the speech data is based on customer speech, speech data based on employee speech, or speech data based on both customer and employee speech; and the address where the speech data is stored.

For example, the speech data identified by speech data number 201 is a contiguous utterance period having a start time of 12:36:03 and an end time of 12:36:16, and including at least some overlapping customer speech and employee speech.

FIG. 8 (b) shows an example of an employee utterance period management table 86.

The employee utterance period management table 86 stores an employee utterance number that is assigned to each utterance period linked to an employee utterance start time denoting the time the utterance period started; an employee utterance end time denoting the time the utterance period ended; a speech number denoting the speech period to which the utterance belongs; an overlap start time denoting the starting time of the overlap period with customer speech; and an overlap end time denoting the end time of the overlap period with customer speech.

For example, because the interval between the utterance periods identified by employee utterance numbers 100 and 101 is less than a specified time (3 seconds in this embodiment of the invention), these utterance periods are handled as a single speech period to which the same speech number is assigned. The table also shows that all of the utterance periods identified by employee utterance number 100 overlap customer speech.

FIG. 8 (c) shows an example of the customer utterance period management table 87.

The customer utterance period management table 87 stores a customer utterance number assigned to each customer utterance period together with a customer utterance start time denoting the time the utterance period started; a customer utterance end time denoting the time the utterance period ended; a speech number denoting the speech period to which the utterance belongs; an overlap start time denoting the starting time of an overlap period with employee speech; and an overlap end time denoting the end time of the employee speech overlap period.

For example, because the interval between the utterance periods identified by customer utterance numbers 101 and 102 is greater than the specified time (3 seconds in this embodiment of the invention), the utterances are handled as belonging to different speech periods and different speech numbers are therefore assigned. The table also shows that 6 seconds of the 13 second long utterance period identified as customer utterance number 101 overlaps employee speech.

The customer service data storage unit 88 is described next.

The customer service data storage unit 88 stores customer service data for each customer service period. More specifically, for each customer service period, the customer service data storage unit 88 stores customer service data including: the customer identification information determined by the customer identification unit 152; the employee identification information determined by the employee identification unit 162; the audio data for the speech data contained in the customer service period selected from the speech data stored in the audio data storage unit 83; the video data corresponding to the video of the customer service period selected from the video data stored in the video data storage unit 84; employee satisfaction data denoting the change (transition) in employee satisfaction in each employee utterance period in the customer service period based on the output from employee satisfaction calculator 157; customer satisfaction data denoting the change (transition) in customer satisfaction in each customer utterance period in the customer service period based on the output from customer satisfaction calculator 156; the sales results denoting whether a sale was made and the total amount of the sale during the customer service event (either during the customer service period or within a specified time after the customer service period ended); and the customer service time (length of the customer service period), the start time, and the end time of the customer service period.

Note that the sales result could be related to the customer identification information contained in the converted data sent from the receipt printer 13.

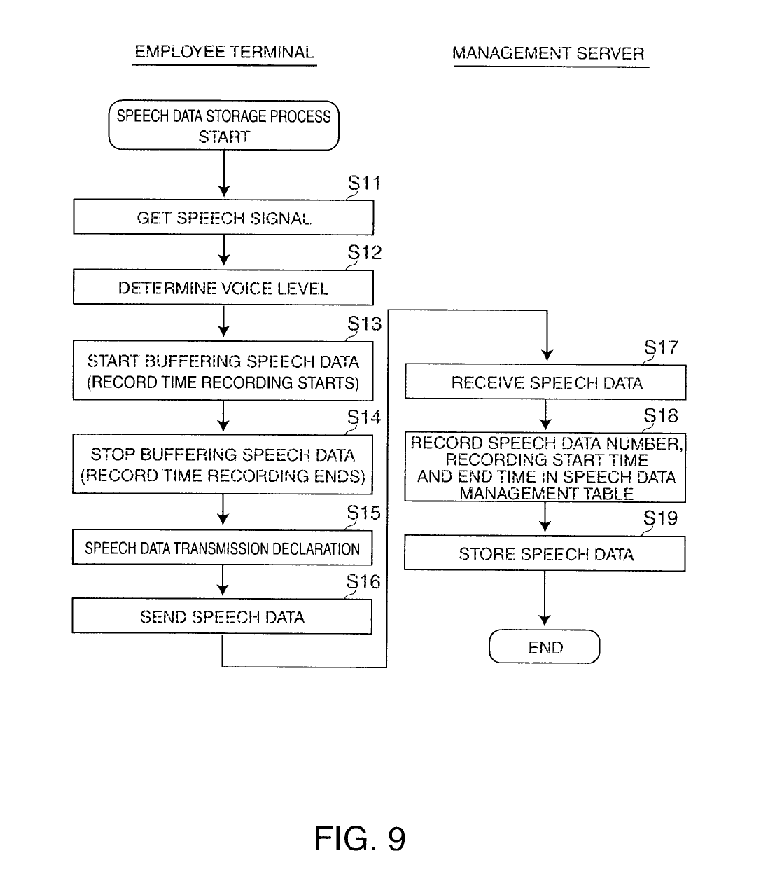

The speech data storage process is described next with reference to the flow chart in FIG. 9. As described above, the employee terminal 5 and management server 15 communicate through the receipt printer 13, but because data only passes through the receipt printer 13, the receipt printer 13 is omitted from the figure.

When the employee terminal 5 acquires a speech signal (audio) from the speech acquisition microphone 2 (S11) (conversation acquisition step), the volume is determined by a power filter in the voice level evaluation function (S12). If the volume is greater than or equal to a specified level, buffering the speech data to the speech data storage area (not shown in the figure) in memory 26 begins (S13). The audio recording start time is also stored in the audio data storage area at this time. If the volume is not greater than or not equal to the specified level, step S11 is repeated (not shown in the figure).

When audio signal reception stops, the recording stop time is determined and stored in the audio data storage area, and buffering ends (S14).

Sending the speech period to the management server 15 is then declared (S15) and the audio data buffered to the audio data storage area is sent with the recording start time and recording end time to the management server 15 (S16).

When speech data is received from the employee terminal 5 (S17), the management server 15 (control unit 53) records a unique speech data number, recording start time, and recording end time to the speech data management table 85 (see FIG. 8 (a)) (S18). The speech data is also stored to the speech data storage address (a specific folder) specified in the speech data management table 85 (S19).

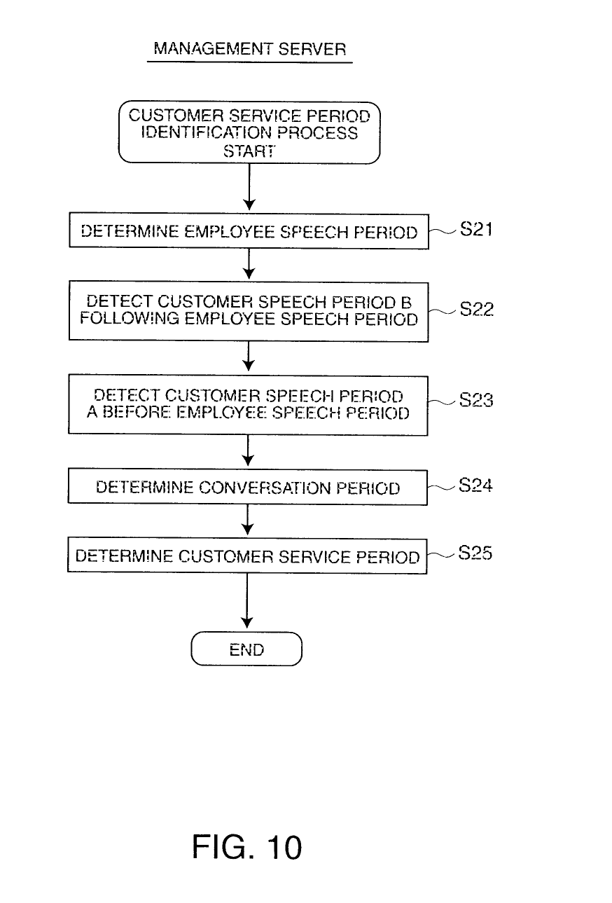

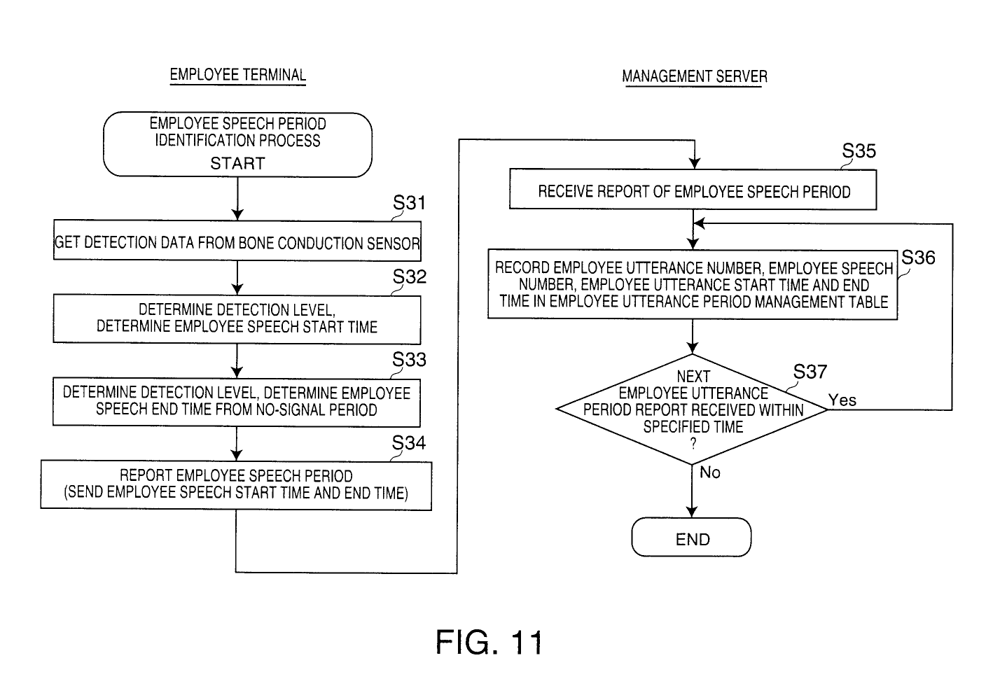

The customer service period identification process is described next with reference to the flow charts in FIG. 10 to FIG. 13. FIG. 10 is a flow chart showing the main process (customer service period identification process), and FIG. 11 to FIG. 13 show subroutines in the main process.

As shown in FIG. 10, after an employee speech period is identified (S21), the management server 15 (control unit 53) detects the customer speech period B following the employee speech period (S22), and detects the customer speech period A preceding the employee speech period (S23). These steps S21 to S23 thus identify a conversation period (S24, see FIG. 5 (a)). A customer service period is identified by repeating steps S21 to S24 (S25, see FIG. 5 (b)).

Referring to the flow chart in FIG. 11, the employee speech period identification process executed as step S21 in FIG. 10 is described next.

When output data from the bone conduction sensor 1 is received (S31), the employee terminal 5 determines the detected sound level using a power filter of the employee utterance period identification function, sets the time of detection (detection time) as the employee utterance start time if the detected level is greater than or equal to a specified level, and writes to memory 26 (S32).

The employee terminal 5 then evaluates the detected level again using a power filter of the employee utterance period identification function, and if the detected level is less than a specified level for at least a specified time (a no-signal period occurs), sets the time the detected level was last greater than or equal to the specified level as the employee utterance period end time, and writes to memory 26 (S33).

The employee terminal 5 then reports that an employee utterance period occurred to the management server 15 (S34). The employee terminal 5 also sends the employee utterance start time and employee utterance end time from memory 26.

When an employee utterance period occurrence report is received from the employee terminal 5 (S35), the management server 15 (control unit 53) records the uniquely assigned employee utterance data number, the employee speech number assigned to each employee speech period, and the employee utterance start time and employee utterance end time in the employee utterance period management table 86 (see FIG. 8 (b)) (S36).

Whether an occurrence report for a next employee utterance period is received within a specified time is then determined (S37). If a report was received (S37 returns Yes), the management server 15 (control unit 53) records the unique employee utterance data number, the same employee speech number as above, the employee utterance start time and the employee utterance end time (S36). This enables defining one employee utterance period and the next occurring employee utterance period as a single continuous speech period. If a report of a next employee utterance period is not received within the specified time (S37 returns No), the employee speech period is determined to have ended, and this process ends.

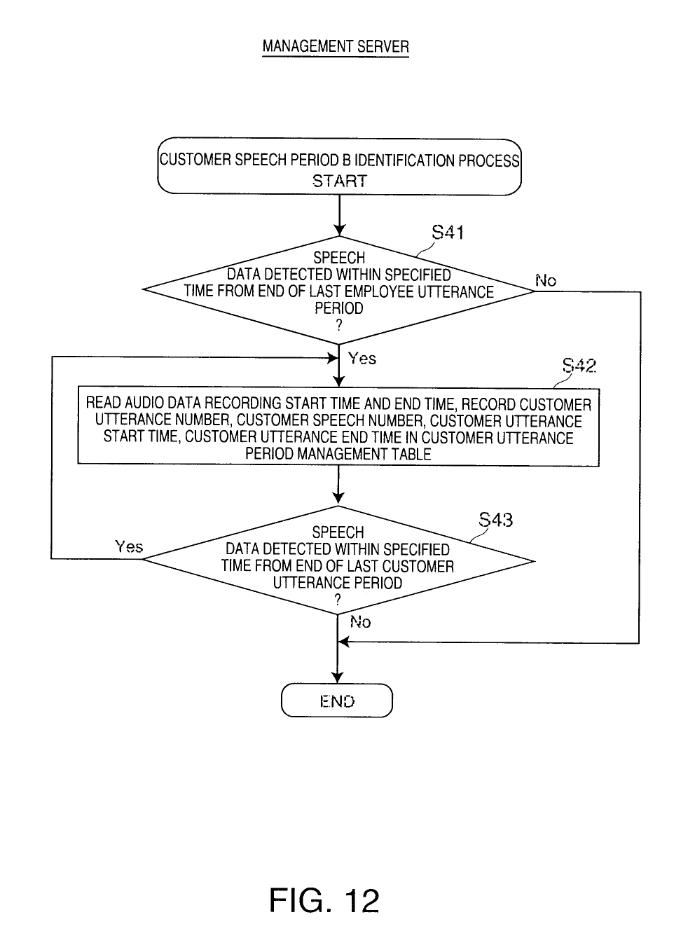

The process of identifying customer speech period B shown as step S22 in FIG. 10 is described next with reference to the flow chart in FIG. 12.

After identification of the employee speech period ends, the management server 15 (control unit 53) references the speech data management table 85, and determines if speech data was detected within a specific time after the employee utterance end time of the last employee utterance period (S41). If there was no speech data (S41 returns No), there is no customer speech period B and this process ends.

If there was speech data (S41 returns Yes), the management server 15 (control unit 53) reads the recording start time and recording end time of the speech period from the speech data management table 85, and records the unique customer utterance number, customer speech number assigned to each customer speech period, and the customer utterance start time and customer utterance end time in the customer utterance period management table 87 (S42).

The management server 15 (control unit 53) then references the speech data management table 85 and determines if speech data was detected within a specific time after the customer utterance end time of the last customer utterance period (S43), and if there was (S43 returns Yes), records the unique customer utterance number, the same customer speech number as above, the customer utterance start time, and the customer utterance end time (S42).

This enables defining one customer utterance period and the next occurring customer utterance period as a single continuous speech period. If speech data is not detected within a specific time after the customer utterance end time of the last customer utterance period (S43 returns No), the management server 15 determines that the customer speech period does not continue, and ends the process.

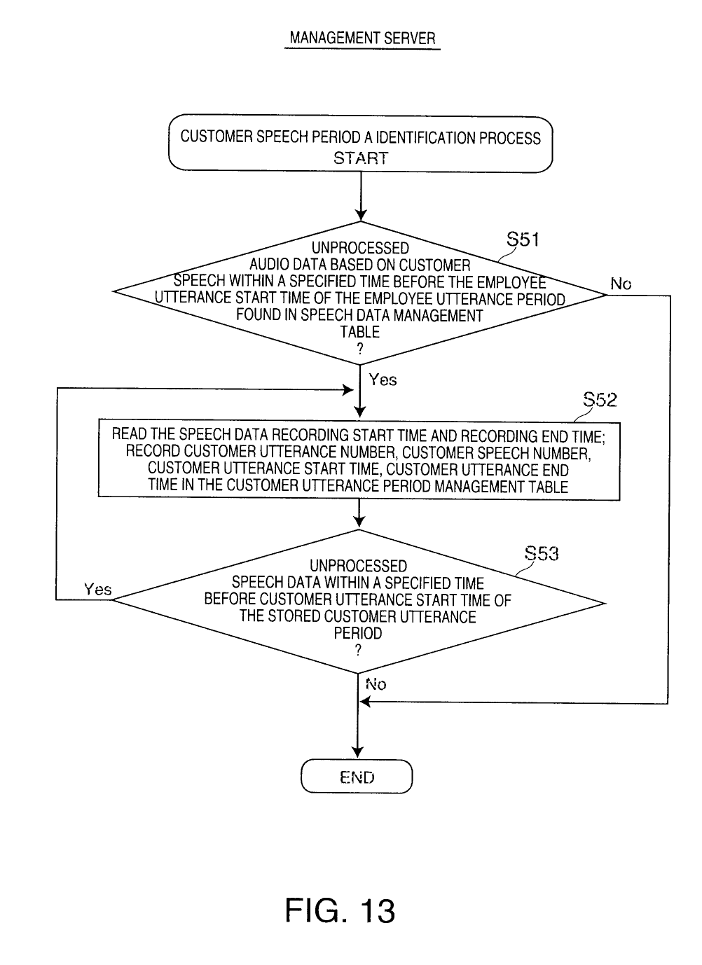

Referring next to the flow chart in FIG. 13, the process of identifying customer speech period A executed as step S23 in FIG. 10 is described below.

After identifying customer speech period B is completed, the management server 15 references the speech data management table 85, and determines if there is any unprocessed customer speech data within a specified time before the employee utterance start time of the employee utterance period (S51). If there is no unprocessed speech data (S51 returns No), there is no customer speech period A and the process ends. If there is unprocessed speech data (S51 returns Yes), the management server 15 reads the recording start time and the recording end time of the speech data, and records the unique customer utterance number, the customer speech number assigned to each customer speech period, the customer utterance start time and the customer utterance end time in the customer utterance period management table 87 (S52).

The management server 15 then references the speech data management table 85, and determines if there is any unprocessed speech data within a specified time before the customer utterance start time of the stored customer utterance period (S53), and if there is (S53 returns Yes), reads the recording start time and recording end time of the speech data, and records the unique customer utterance number, the same customer speech number as above, the customer utterance start time and the customer utterance end time (S52).

As a result, the previously stored customer utterance period and customer utterance period that was just identified can be defined as a single speech period.

If there is no unprocessed speech data within the specified time before the customer utterance start time of the stored customer utterance period (S53 returns No), the management server 15 determines that there is no preceding customer speech period and ends the process.

Data can thus be written to the speech data management table 85, employee utterance period management table 86, and customer utterance period management table 87, and the employee speech period, and the customer speech period A and customer speech period B before and after the employee speech period can be identified by the processes shown in FIG. 9 to FIG. 13.

Detection of overlap between an employee speech period and customer speech period (a speech overlap period) is described next.

After identifying the speech periods, the management server 15 references the employee utterance period management table 86 and customer utterance period management table 87, and detects and records any overlap periods in tables 85, 86, and 87.

More specifically, the management server 15 references the employee utterance period management table 86, and sets the earliest employee utterance start time and the latest employee utterance end time with the same speech number as the start time and end time, respectively, of the employee speech period.

Likewise, the management server 15 references the customer utterance period management table 87, and sets the earliest customer utterance start time and the latest customer utterance end time with the same speech number as the start time and end time, respectively, of the customer speech period.

Whether there is an overlap between the employee speech period and customer speech period is then determined. If there is an overlap, the overlap period (the overlap start time and the overlap end time) is stored in the employee utterance period management table 86 and customer utterance period management table 87, and an overlap flag is set in the speech data management table 85 (equivalent to “customer/employee” in the overlap flag column in FIG. 8 (a)).

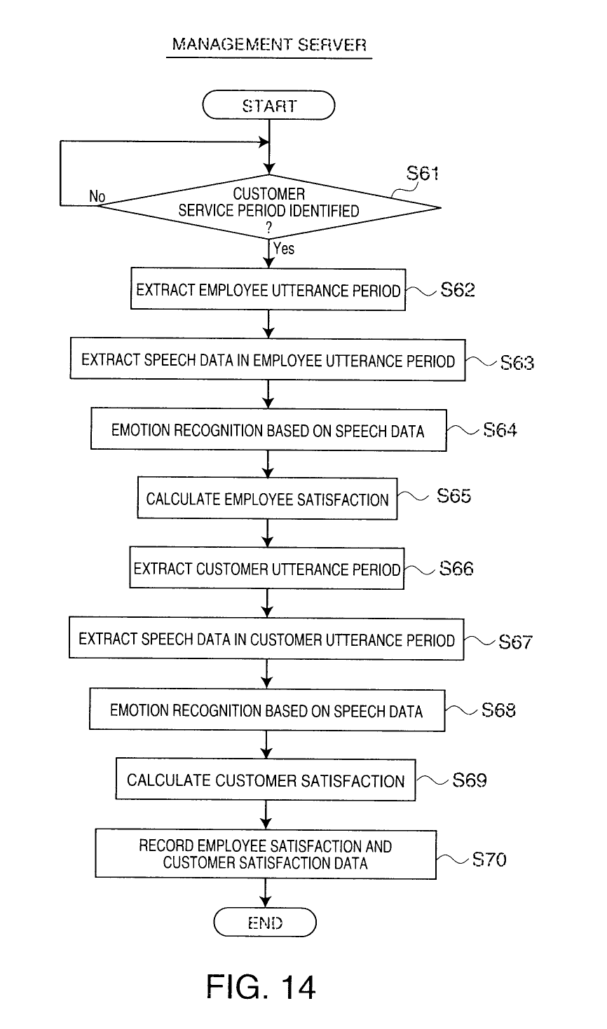

The satisfaction recording process is described next with reference to FIG. 14.

The satisfaction recording process records employee satisfaction data denoting employee satisfaction and customer satisfaction data denoting customer satisfaction as customer service data in the management server database DB. The satisfaction recording process is triggered when a customer service period ends and the customer service period is identified.

As shown in FIG. 14, when a customer service period is identified (S61 returns Yes), the management server 15 (control unit 53) extracts all employee utterance periods contained in that customer service period from the employee utterance period management table 86 (S62). The speech data for each extracted employee utterance period is then extracted from the speech data management table 85 (S63).

Once the speech data is extracted from each employee utterance period, the emotion recognition unit 155 applies emotion recognition to the extracted speech data (S64, emotion recognition step). employee satisfaction calculator 157 then calculates employee satisfaction in each employee utterance period based on the emotion recognition result for each employee utterance period (S65, satisfaction calculation step).

More specifically, the emotion recognition unit 155 calculates emotion values representing particular emotional states such as happy, laughing, anger, sadness, normal, and excited based on the results of emotion recognition, and calculates employee satisfaction based on the calculated emotion values. In this embodiment of the invention, employee satisfaction data includes employee satisfaction value calculated for each employee utterance period in the customer service period.

When employee satisfaction is calculated, all customer utterance periods contained in the customer service period are extracted from the customer utterance period management table 87 (S66), and the speech data for each extracted customer utterance period is extracted from the speech data management table 85 (S67).

Once the speech data is extracted from each customer utterance period, the emotion recognition unit 155 applies emotion recognition to the extracted speech data (S68, emotion recognition step). The customer satisfaction calculator 156 then calculates customer satisfaction in each customer utterance period based on the emotion recognition result for each customer utterance period (S69, satisfaction calculation step).

The customer satisfaction data includes customer satisfaction value calculated for each customer utterance period in the customer service period.

Note that the algorithm for calculating employee satisfaction using the emotion values, and the algorithm for calculating customer satisfaction from the emotion values, may be the same algorithm, or algorithms that differ according to the factors whereby each emotion affects satisfaction and differences in the effect of those factors.

Once employee satisfaction and customer satisfaction are calculated, the customer service data recorder 159 links and records employee satisfaction data and customer satisfaction data in each customer service period as the customer service data for each customer service period unit in the customer service data storage unit 88 (S70, customer service data recording step). The customer service data recorder 159 also records the customer service time, start time and end time of the customer service period, the employee identification information, the customer identification information, sales result, audio data and video data linked to employee satisfaction data and customer satisfaction data (customer service data).

This completes the satisfaction recording process. Note that employee satisfaction data and customer satisfaction data are related by utterance period time measurements (start time and/or end time).

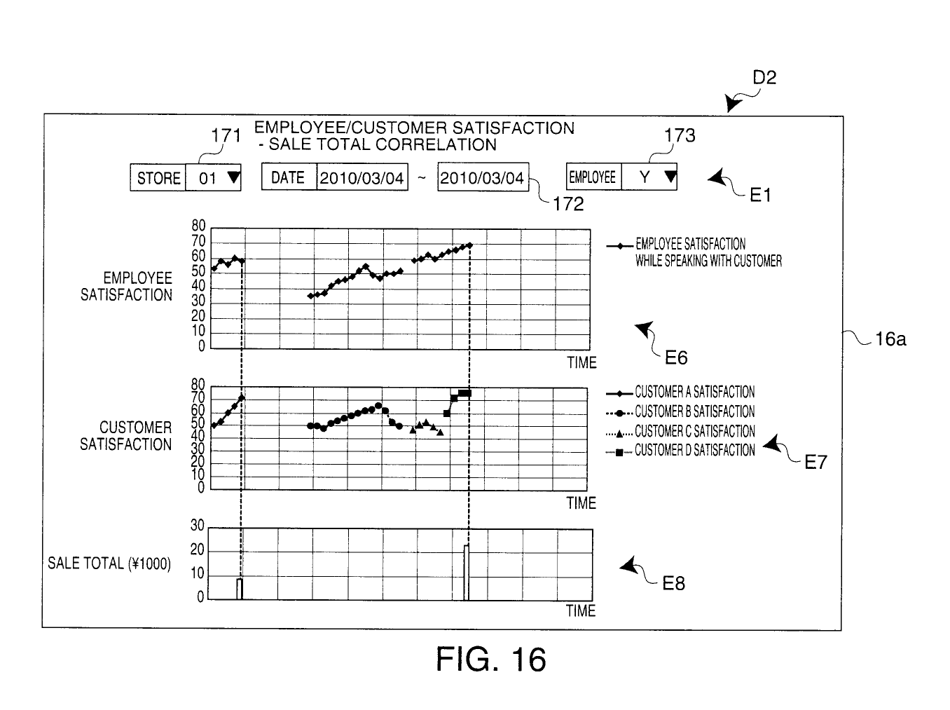

An example of a window D for checking the recorded customer service data is described next with reference to FIG. 15 and FIG. 16. The screen display unit 160 displays a first window D1 that displays customer service related data in a table format (see FIG. 15), or a second window D2 that displays customer service related data in a graph (see FIG. 16), as selected by the user.

The first window D1 is described first with reference to FIG. 15. As shown in FIG. 15, the first window D1 includes a display conditions input area E1 for inputting the display conditions, a data display area E2 for displaying the customer service data matching the input display conditions, and a playback control area E3 for controlling reproduction of audio data contained in the customer service data.

The display conditions input area E1 includes a store ID menu 171 for selecting a store ID, a date input field 172 for inputting a date range, and an employee menu 173 for selecting an employee. Menus 171 and 173 are pulldown menus enabling selecting particular values (such as the store ID or employee name). The store, date range, and employee can therefore be input as display criteria.

The data display area E2 shows data based on the customer service data matching the input display conditions as a data table 174. More specifically, the customer service data for all customer service periods found in the input date range are extracted from the customer service data for the input employee working at the input store, and the extracted customer service data is compiled in a data table 174.

Based on the customer service data from each customer service period, this embodiment of the invention displays for each customer service period: a customer service period identification number (the conversation number in this example); customer service period start time; customer service period end time; the average of employee satisfaction in each employee utterance period in that customer service period (shown as employee satisfaction in the figure); the employee-customer speaking ratio in the customer service period; the name of the customer in the customer service period; the average of customer satisfaction values for each customer utterance period in that customer service period (shown as customer satisfaction in the figure); and the total amount of the sale related to that customer service period and transaction identification information (transaction number in the figure).

The playback control area E3 is an operating area for playing back the audio recorded in the one customer service period selected from the data table 174. The playback control area E3 includes a button group 175 for playing back the audio recorded in the customer service period, a progress bar 176 displaying the playback position, and a volume control slider 177.

The progress bar 176 includes a time scale with minute marks on the X-axis. The recording playback unit 161 reproduces the recorded audio linked to the selected customer service period as controlled by operating these graphic elements. The progress bar 176 differentiates employee speech periods and customer speech periods. As a result, the user can replay the audio recorded in a selected employee speech period or customer speech period. Note that the scale in the progress bar 176 may be in hour units instead of minutes. In addition, the scale units and intervals between the markings could also be changed according to the length of the audio recording so that the total playback time of the recorded audio in the customer service data can be known.

The second window D2 is described next with reference to FIG. 16.

The second window D2 displays the correlation between employee satisfaction data, customer satisfaction data, and sales data. More specifically, the second window D2 has a display conditions input area E1, an employee satisfaction display area E6 that graphs employee satisfaction data, a customer satisfaction display area E7 that graphs customer satisfaction data, and a sales display area E8 that graphs sales data representing the sale result.

The display conditions input area E1 is the same as in the first window D1, and display areas E6, E7, E8 display customer service data matching the display criteria input to the display conditions input area E1.

The employee satisfaction display area E6 shows a broken line graph of employee satisfaction data in the customer service period matching the input display conditions with time on the x-axis and employee satisfaction on the y-axis. In this example employee satisfaction values for each employee utterance period in one customer service period that continues without interruption for a specified time are plotted and joined by a broken line.

The customer satisfaction display area E7 corresponds to the graph shown in the employee satisfaction display area E6, and is a broken line graph showing customer satisfaction data in the customer service period matching the input display conditions with time on the x-axis and customer satisfaction on the y-axis. Note that the broken lines are differentiated for each customer (using different line types, for example).

The sales display area E8 corresponds to the graphs presented in employee satisfaction display area E6 and customer satisfaction display area E7, and is a bar graph showing the sales total in each customer service period matching the input display conditions with time on the x-axis and sale amount on the y-axis.

### Embodiment 2

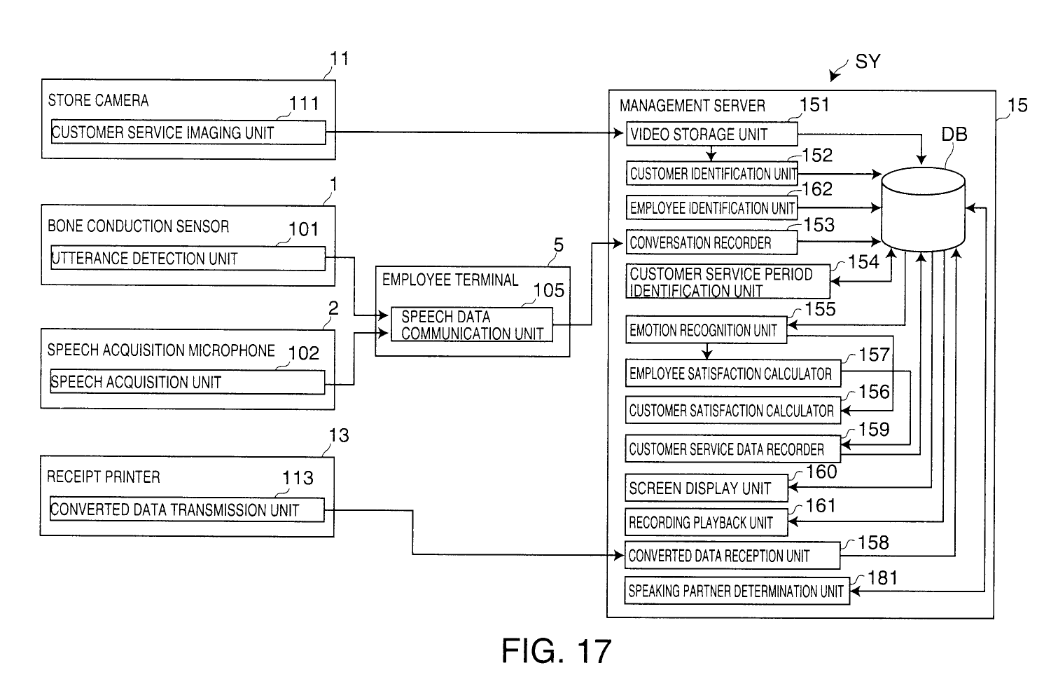

A customer service support system SY according to a second embodiment of the invention is described next with reference to FIG. 17 to FIG. 19.

In addition to conversation with customers, the customer service support system SY according to the second embodiment of the invention also acquires conversation with supervisors and conversation with peers, and based on the speech used in these conversations, calculates and records employee satisfaction in conversations with customers, employee satisfaction in conversations with supervisors, and employee satisfaction in conversations with peers.

Only the differences with the first embodiment are described below. Note that like parts in this embodiment and the first embodiment are identified by like reference numerals, and further description thereof is omitted. Modifications applicable to like parts in the first embodiment are also applicable to this embodiment.

As described above, the speech acquisition unit 102 captures conversation with a supervisor and conversation with a peer. In addition to the parts shown in FIG. 6, the management server 15 has a speaking partner determination unit (evaluation unit) 181 that identifies the category of person (that is, customer, supervisor, or peer) that the employee is speaking with. The speaking partner determination unit 181 analyzes the voice print of the speech data from the other person in a conversation (the “conversation partner”), and based on the voice print recognizes the speaking partner and determines the category of the speaking partner.

Note that similarly to customer recognition, the speaking partner could be recognized and evaluated based on video data from a store camera 11.

In the satisfaction recording process according to the second embodiment of the invention, the speaking partner determination unit 181 determines the category of the speaking partner before the sequence of steps (S62 to S65 in FIG. 14) that calculate employee satisfaction, and when recording the customer service data (S70 in FIG. 14) records the identified category of the speaking partner linked to customer satisfaction data in the management server database DB (customer service data storage unit 88). If the result of speaking partner category identification is a supervisor or peer, the steps for calculating customer satisfaction are skipped (S66 to S69 in FIG. 14).

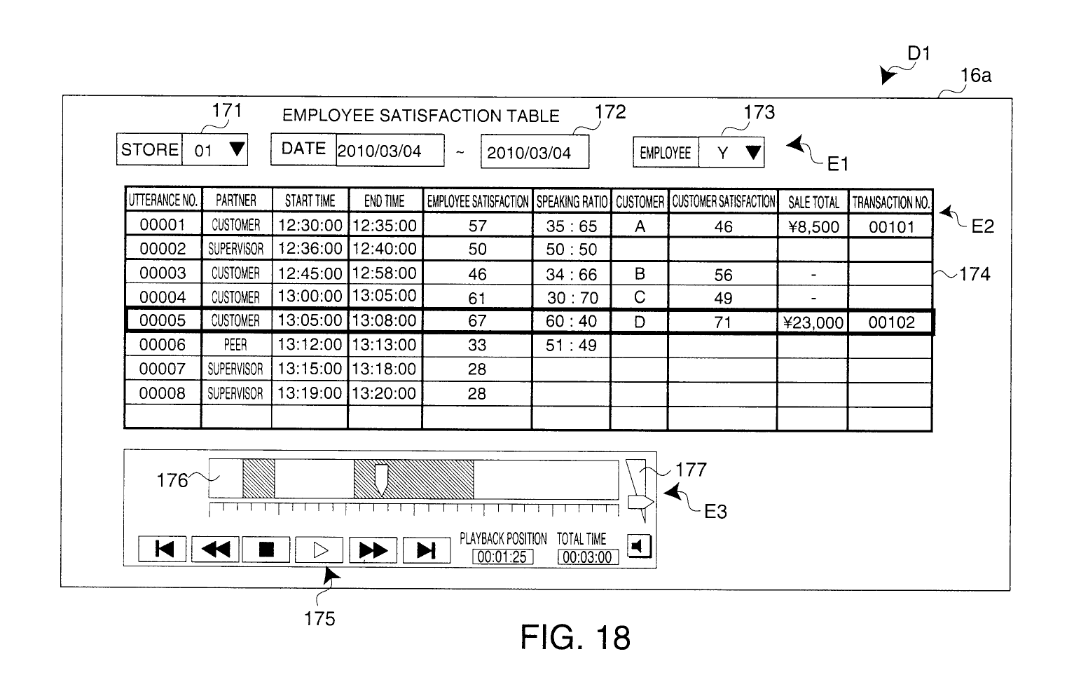

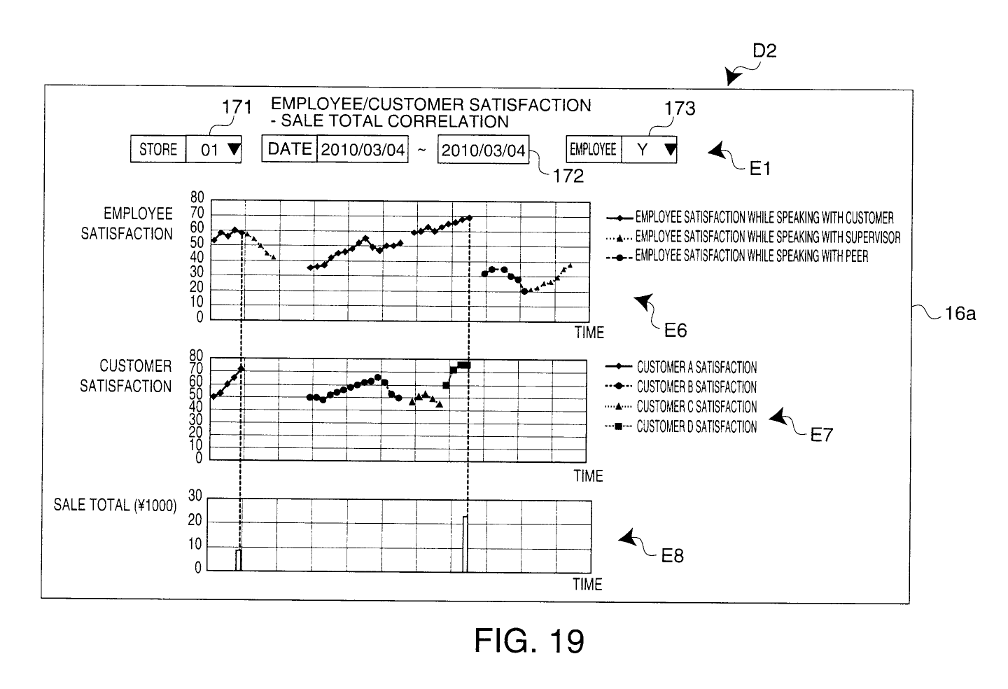

The window D according to the second embodiment of the invention is described next with reference to FIG. 18 and FIG. 19. The screen display unit 160 adds data from supervisor and peer conversations, and displays customer satisfaction data linked to the category of speaking partner (the “partner” field in the figure), in the window D. More specifically, as shown in FIG. 18, data from supervisor and peer conversations is added, and a field showing the category of speaking partner is added, to the data table 174 in the first window D1.

As shown in FIG. 19, a broken line connecting data from supervisor and peer conversations is added to the second window D2, and the broken lines are differentiated for each category of speaking partner (customer, supervisor, peer) (differentiated by line type in this example).

By recording employee satisfaction data and customer satisfaction data linked together as customer service data in the first and second embodiments of the invention, the correlation between employee satisfaction and customer satisfaction can be determined from the customer service data. As a result, whether customer satisfaction changed due to factors related to employee satisfaction can be determined. In addition, because change in employee satisfaction can be estimated from customer satisfaction, and customer satisfaction can be estimated from employee satisfaction, whether or not customer satisfaction and the employee satisfaction were accurately calculated can be determined, and the reliability of the calculated customer satisfaction and employee satisfaction can be compensated for.

Furthermore, because employee satisfaction data and customer satisfaction data are recorded for each customer service period, the correlation between employee satisfaction and customer satisfaction can be determined by customer service period unit.

In addition, because the customer service period start time and/or end time are also recorded linked to employee satisfaction data and customer satisfaction data, the time that employee satisfaction data and customer satisfaction data were recorded can also be known.

Yet further, by recording employee identification information and customer identification information linked to employee satisfaction data and customer satisfaction data, which employee and which customer were involved in the conversation from which the recorded employee satisfaction data and customer satisfaction data were acquired can also be known.

Note that a configuration in which only employee identification information or only customer identification information is recorded is also conceivable.

In addition, by recording sales results linked to employee satisfaction data and customer satisfaction data, the correlation between sales and employee satisfaction and customer satisfaction can also be determined.

Yet further, by recording the audio data from the conversation linked to employee satisfaction data and customer satisfaction data, the content of the conversation from which employee satisfaction data and customer satisfaction data were obtained can also be determined.

Furthermore, by differentiating the identified employee speech periods and customer speech periods displayed in the progress bar 176 in the first window D1, employee speech periods and customer speech periods in the conversation can be checked, and the employee-customer speaking ratio and speaking interval can be checked.

Furthermore, by displaying the window D based on the customer service data, the recorded customer service data can be checked on the window D.

Furthermore, because the category of the speaking partner is determined and displayed linked to employee satisfaction data in the second embodiment of the invention, the category of partner involved in the conversation from which employee satisfaction data was acquired can also be determined.

The embodiments described above record employee satisfaction data linked to customer satisfaction data, and display the correlation therebetween on the window D, but a configuration that determines and displays the correlation between employee satisfaction and customer satisfaction based on the recorded employee satisfaction data and customer satisfaction data is also conceivable.

More specifically, a configuration that also has a correlation coefficient calculation unit, which calculates a correlation coefficient for the correlation between employee satisfaction and customer satisfaction per unit time (such as per a specified period of time, per customer service period, or per conversation period) based on employee satisfaction data and customer satisfaction data, and displays the calculated correlation coefficient on the window D by means of the screen display unit 160 is also conceivable. A configuration that determines the reliability of employee satisfaction data and/or customer satisfaction data based on the calculated correlation coefficient, and displays the result, is also conceivable.

Each of the foregoing embodiments could also display video data related to each customer service period in the window D. For example, a configuration that has a video data display area for displaying video data in the first window D1, and a video playback control area for controlling playback of the video data in the customer service data, and replays the video data from the customer service period as controlled by operations in the video playback control area, is also conceivable.

### Embodiment 3

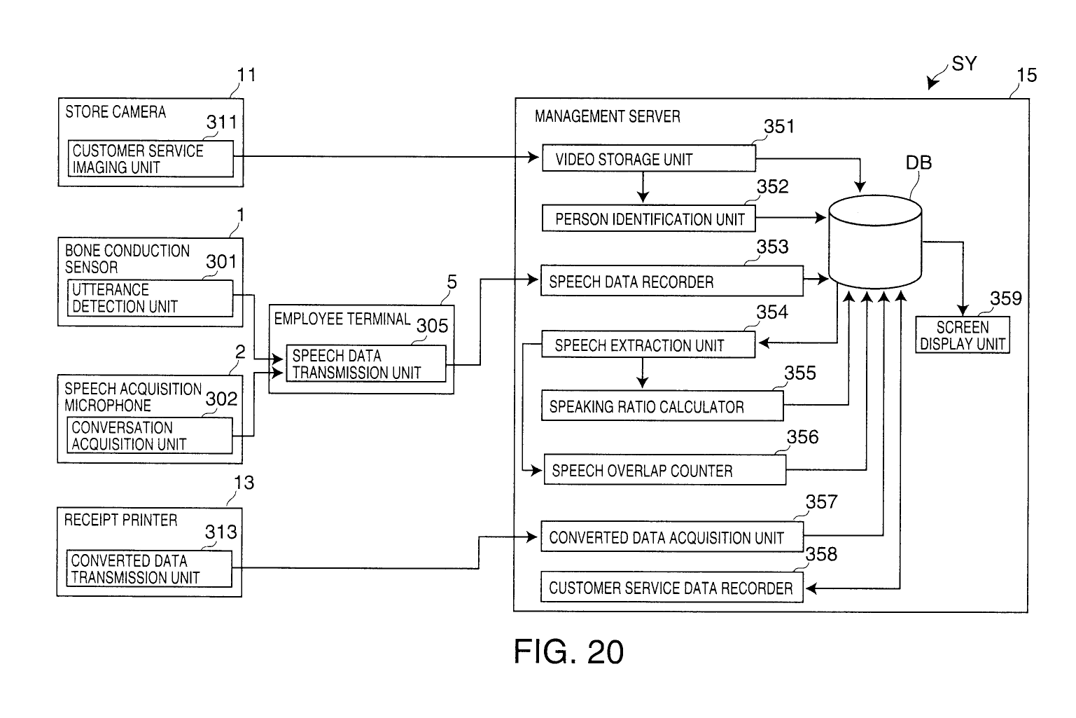

A third embodiment of the invention is described next with reference to FIG. 20 to FIG. 25. This embodiment of the invention calculates and links the employee-customer speaking ratio to sales information for collection as marketing data. In addition to the functions shown in FIG. 4, the management server 15 in this embodiment of the invention has a speaking ratio calculation function and a speech overlap counting function rendered by the control unit 53.

The speaking ratio calculation function calculates the speaking ratio between the employee and customer in each customer service period (a period when an employee is serving a customer). The speech overlap counting function counts the number of times conversation overlaps in each customer service period.

Other functions are the same as described in the first embodiment, and further description thereof is omitted.

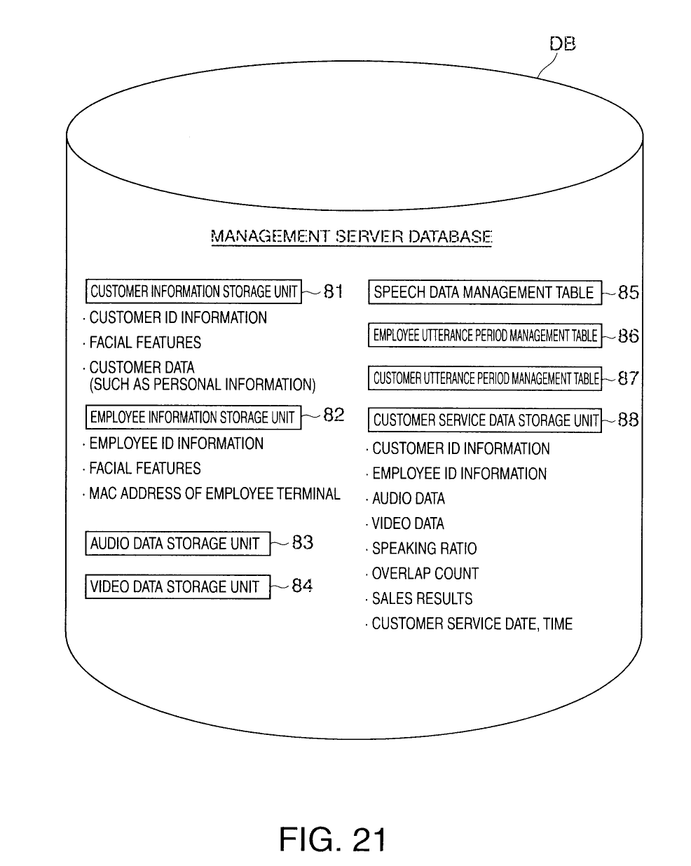

The configuration of the customer service support system SY according to the third embodiment of the invention is described next with reference to FIG. 20 and FIG. 21.

FIG. 20 is a block diagram of the customer service support system SY.

The main functional unit of the store camera 11 is the customer service imaging unit 311. The customer service imaging unit 311 records customer service events between employees and customers. In this embodiment of the invention the customer service imaging unit 311 is always recording, and outputs the captured video data continuously to the management server 15.

The main functional unit of the bone conduction sensor 1 is an utterance detection unit 301. The utterance detection unit 301 detects that the employee said something and the utterance period based on bone conducted sound.

The main functional unit of the speech acquisition microphone 2 is a conversation acquisition unit 302. The conversation acquisition unit 302 captures speech (audio signals) from conversations between employee and customer.

The main functional unit of the employee terminal 5 is a speech data transmission unit 305. The speech data transmission unit 305 detects speech using a power filter in the voice level evaluation function, and sends speech data greater than or equal to a preset sound level to the management server 15. Based the detection result from the utterance detection unit 301 and the speech acquired by the conversation acquisition unit 302, the speech data transmission unit 305 identifies the employee utterance period (employee utterance period identification function) and reports detection of an employee utterance period to the management server 15.

The main functional unit of the receipt printer 13 is a converted data transmission unit 313. The converted data transmission unit 313 sends the converted data obtained by converting the receipt data output from the POS terminal 12 to XML as described above to the management server 15.

The main functional units of the management server 15 include a video storage unit 351, person identification unit 352, speech data recorder 353, speech extraction unit 354, speaking ratio calculator 355, speech overlap counter 356, converted data acquisition unit 357, customer service data recorder 358, and management server database DB.

The video storage unit 351 acquires video data from the customer service imaging unit 311, and records the video data in the management server database DB.

The person identification unit 352 identifies employees and customers based on the facial features contained in the video data. For example, for employees, employee identification information related to the facial features of the employee are stored in the management server database DB (see the employee information storage unit 82 in FIG. 21). Employees could also be identified by analyzing images captured by the store camera 11 to detect faces, comparing a facial feature value calculated by normalizing the detected facial images with the facial feature value of the employee stored in the management server database DB, and identifying the employee as the person with the greatest resemblance. Customers could be similarly identified by storing customer identification information and related customer facial features in the management server database DB (see the customer information storage unit 81 in FIG. 21), comparing a calculated facial feature value with the facial feature values of numerous customers stored in the management server database DB, and identifying the customer as the person with the greatest resemblance.

Note that the employee identification information and customer identification information detected by the person identification unit 352 are linked together when stored in the customer service data storage unit 88.

The speech data recorder 353 records conversations between employees and customers, that is, records the speech data sent from the speech data transmission unit 305, in the management server database DB.

The speech extraction unit 354 extracts employee speech and customer speech from the acquired conversation (audio data). More specifically, based on the output from the utterance detection unit 301, the speech extraction unit 354 determines if the speech contained in the conversation is employee speech or customer speech, and based on this result extracts both speech entities. Note that speech is extracted by utterance period unit or speech period unit.

The speaking ratio calculator 355 refers to the speaking ratio calculation unit of the control unit 53, and calculates the speaking ratio between employee and customer. More specifically, the speaking ratio calculator 355 calculates the speaking ratio in each conversation period, and based on the result in each conversation period, calculates the speaking ratio (average speaking ratio) in each customer service period. The calculated speaking ratio is stored as part of the customer service data (second customer service data) in the customer service data storage unit 88. The algorithm for calculating the speaking ratio is described below.

The speech overlap counter 356 refers to the speech overlap counting function of the control unit 53, and measures the speech overlap count (the number of overlap periods), which is the number of times employee speech and customer speech overlap, in each customer service period. The overlap count is stored as part of the customer service data in the customer service data storage unit 88.

The converted data acquisition unit 357 acquires and records the converted data sent from the converted data transmission unit 313 of the receipt printer 13 in the management server database DB. Note that this converted data is used to acquire sale information, which is recorded as part of the customer service data. Note, further, that only information enabling determining if a sale was made and the amount of the sale, such as customer identification information (a member number, for example), receipt number (transaction number), and sale total, could be extracted and recorded as the converted data, or all of the converted data could be recorded in the management server database DB.

The customer service data recorder 358 stores a customer service data record including the employee identification information and customer identification information output from the person identification unit 352 and the result from the speaking ratio calculator 355 in each customer service period in the management server database DB. Note that the customer identification information and employee identification information are determined from the facial features as described above. In addition, the employee identification information and MAC address of the employee terminal 5 are also stored with the customer service data (see the employee information storage unit 82 in FIG. 21) so that the video data and audio data acquired by the management server 15 can be linked together.

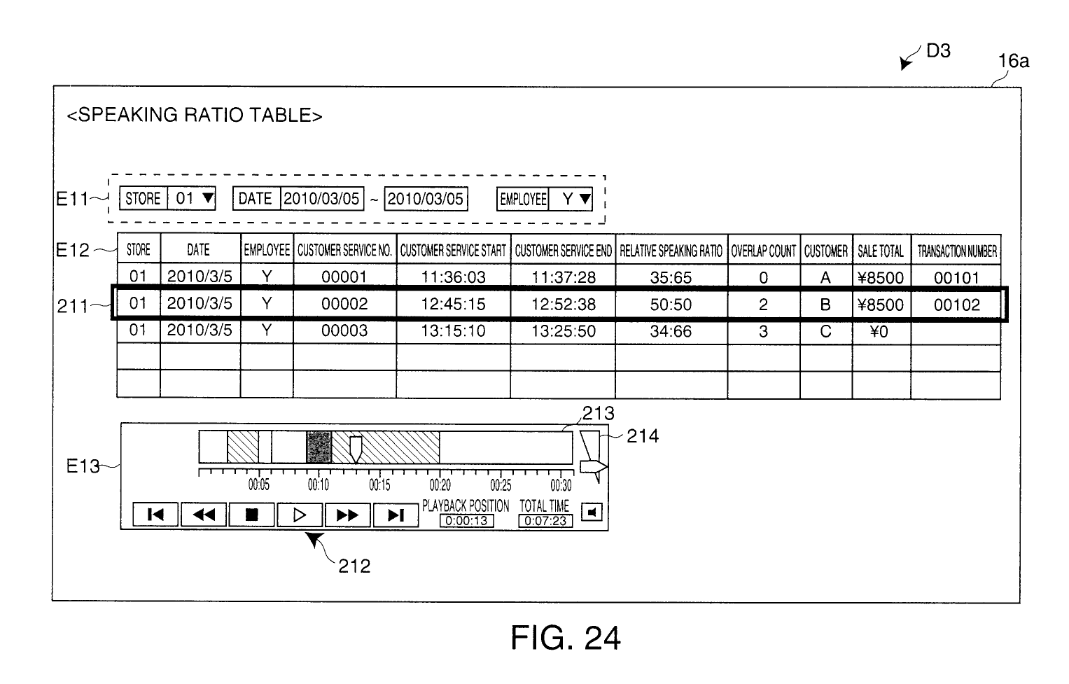

The screen display unit 359 displays a window D for reviewing the recorded customer service data on the display screen 16a (see FIG. 24).

FIG. 21 describes the management server database DB according to the third embodiment of the invention. The management server database DB functions as a customer information storage unit 81, employee information storage unit 82, audio data storage unit 83, video data storage unit 84, speech data management table 85, employee utterance period management table 86, customer utterance period management table 87 and customer service data storage unit 88. The management server database DB may installed individually in each store, or shared by a plurality of stores.

The customer information storage unit 81 stores customer identification information (such as a customer ID) with the facial features of the customer and other customer data.

The employee information storage unit 82 records employee identification information (such as an employee ID) with the facial features of the employee and the MAC address of the employee terminal 5.

The audio data storage unit 83 stores the audio data that is continuously recorded by the speech data recorder 353 together with a time stamp.

The video data storage unit 84 records the video data that is continuously captured by the customer service imaging unit 311 together with a time stamp.

The speech data management table 85, employee utterance period management table 86 and customer utterance period management table 87 are as described in FIGS. 8 (a), (b), and (c).

The customer service data storage unit 88 stores customer service data records including the customer identification information and employee identification information output from the person identification unit 352; the audio data corresponding to the speech data in the customer service period extracted from the audio data stored in the audio data storage unit 83; the video data corresponding to the video data for the customer service period extracted from the video data stored in the video data storage unit 84; the speaking ratio during the customer service period output from the speaking ratio calculator 355; the overlap count in the customer service period output from the speech overlap counter 356; sale information denoting if a sale was made (during the customer service period or within a specified time after the end of the customer service period) and the amount of the sale resulting from the customer service event; and customer service date and time information denoting the customer service date and the start and end times of the customer service period.

Note that the customer service data related to particular sale information could be identified using customer identification information by comparing the facial feature value of the customer calculated from the image of the customer captured by the store camera 11 located at the checkout counter with the facial feature values of numerous customers previously stored in the management server database DB, and retrieving the customer identification information for the customer with the greatest resemblance.

The customer service data related to particular sale information could also be identified using customer identification information contained in the converted data from the receipt printer 13.

In addition, when employee identification information (such as the operator name or employee number) is contained in the converted data, the sale information is preferably related to the customer service data containing the matching customer identification information and employee identification information.

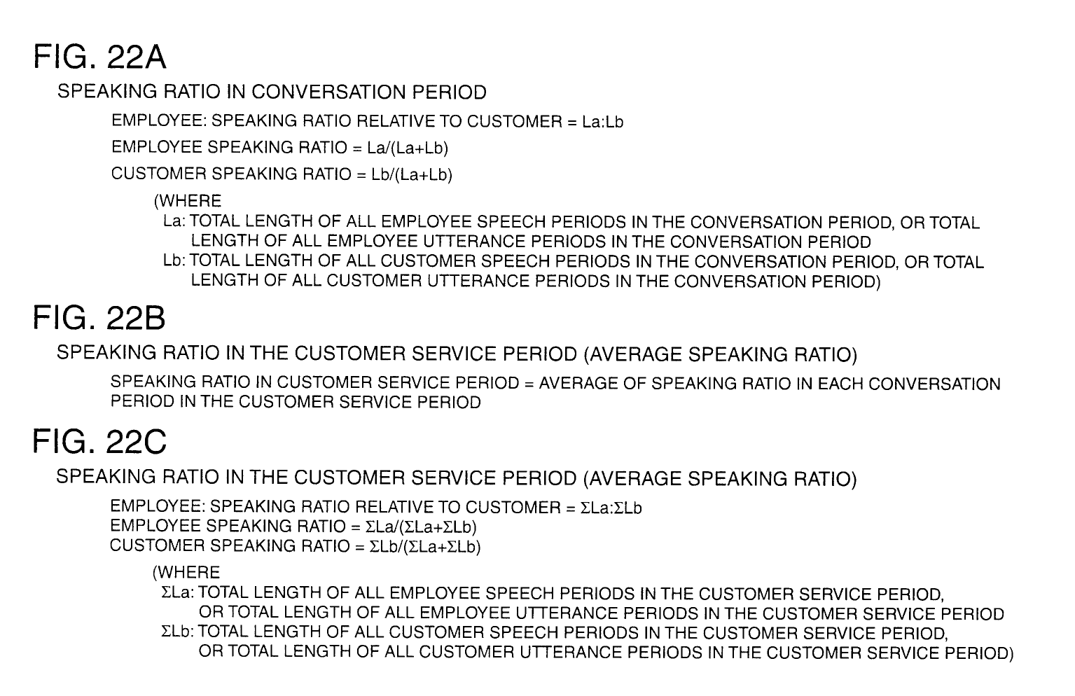

The algorithm used to compute the speaking ratio is described next with reference to FIG. 22. As shown in FIG. 22 (a), the speaking ratio of a conversation period can be calculated in three ways: the relative employee-customer speaking ratio, the employee speaking ratio, and the customer speaking ratio.

For example, if the total length of all employee speech periods in the conversation period is La, and the total length of all customer speech periods in the conversation period is Lb, the relative employee-customer speaking ratio is La:Lb. The employee speaking ratio is La/(La+Lb), and the customer speaking ratio is Lb/(La+Lb). The length of a speech period is the length from the start time to the end time of the speech period.

Note, further, that La may be defined as the total length of all employee utterance periods in the conversation period. More specifically, the speech period may include interval X as shown in FIG. 5 (a), and La could be defined as the length of the speech period minus the length of the interval. For example, in the case of customer speech period A in FIG. 5 (a), La is the total of the time from the start to the end time of utterance period 1 and the time from the start to the end time of utterance period 2. Lb can be defined in the same way.

As shown in FIG. 22 (b), the speaking ratio in the customer service period can be calculated as the average of the speaking ratios of all conversation periods in the customer service period. The speaking ratio in the customer service period can also be expressed using statistical values such as the maximum, minimum, and median instead of the average of the speaking ratios in each conversation period.

The speaking ratio in the customer service period can also be calculated using the same three patterns, that is, the relative employee-customer speaking ratio, the employee speaking ratio, and the customer speaking ratio, depending upon the pattern used as the speaking ratio in the conversation period (see FIG. 22 (a)).

The speaking ratio in the customer service period could alternatively be calculated using the algorithm shown in FIG. 22 (c). If the total length of all employee speech periods in the customer service period is ΣLa, and the total length of the customer speech periods in the customer service period is ΣLb, the relative employee-customer speaking ratio is ΣLa:ΣLb. The employee speaking ratio is ΣLa/(ΣLa+ΣLb), and the customer speaking ratio is ΣLb/(ΣLa+ΣLb).

Similarly to alternatively defining La as the sum of the lengths of all employee utterance periods in the conversation period, ΣLa can be defined as the sum of the lengths of all employee utterance periods in the customer service period.

ΣLb is similarly defined.

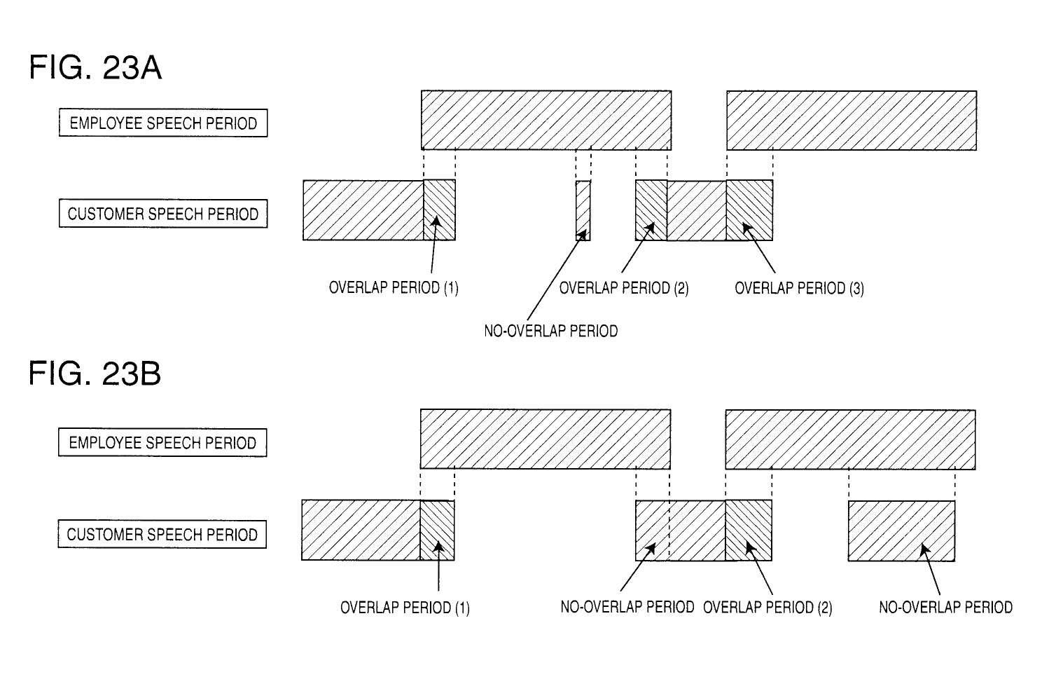

A method of determining the speech overlap count is described next with reference to FIG. 23. In the example shown in FIG. 23 (a), there are four periods where the employee speech period and the customer speech period overlap. However, because the second overlap period is a short utterance period (a speech period that is shorter than a specified time), it is not counted as an overlap period. The overlap count is therefore determined by the three overlap periods (1)-(3).

Note that because overlap periods (2) and (3) occur in the same single speech period, they may be counted as one overlap period. In this case, the overlap count in the example shown in FIG. 23 (a) is 2.

Further alternatively, all overlap periods, including speech periods that are shorter than the specified time, can be included in the overlap period count. In this case, the overlap count in the example shown in FIG. 23 (a) is 4.

Further alternatively, only speech overlaps occurring at the start of employee speech could be used to determine the overlap count as shown in the example in FIG. 23 (b). In this example there are four overlap periods where the employee speech period and customer speech period overlap. However, because the second and fourth overlap periods result from the customer speaking while the employee is already talking, they are not included in the overlap count.

More specifically, an overlap period that occurs when the customer starts speaking after an employee speech period has already started is not included in the overlap count even though a speech overlap occurs. As a result, the two overlap periods (1) and (2) are counted to get the overlap count in this example. By thus including only the overlap periods resulting from the start of employee speech in the overlap count, the quality of the employee's customer service technique can be accurately evaluated.

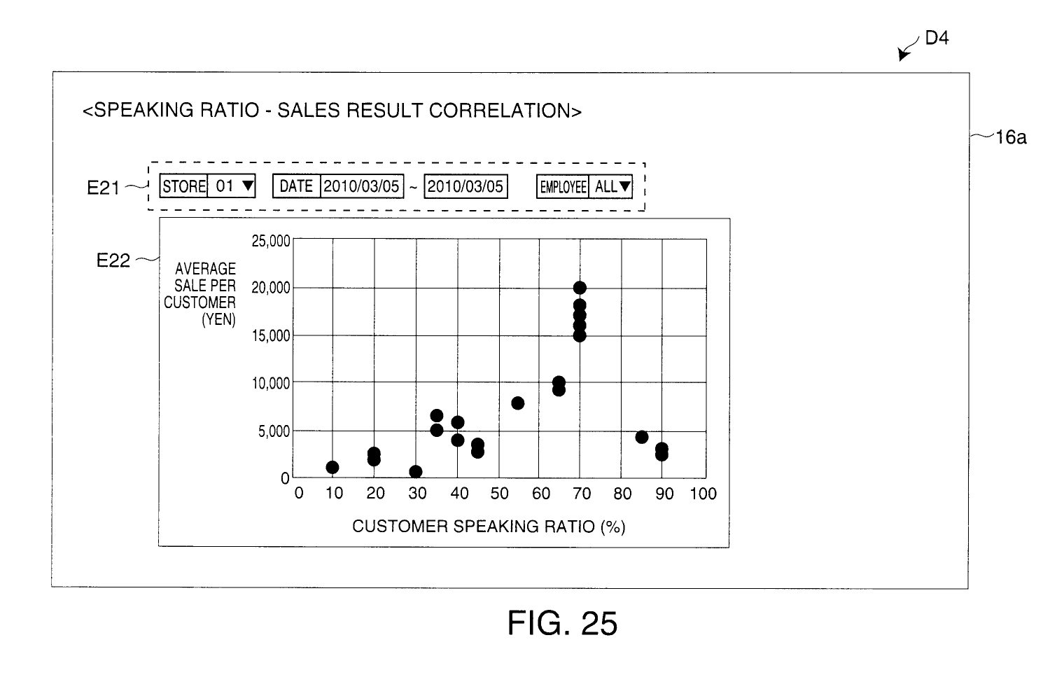

A window D according to the third embodiment of the invention is described next with reference to FIG. 24 and FIG. 25. FIG. 24 shows a window D3 displaying a speaking ratio table. This window D3 includes a display criteria selection area Ell for selecting display (search) criteria, a data display area E12 for displaying the speaking ratio table, and a playback control area E13 for controlling reproduction of audio data contained in the customer service data.

The display criteria selection area E11 enables selecting (inputting) a specific store, date, and employee (person identification information). The customer service data matching the selected (input) conditions is displayed in the data display area E12.

Note that a customer (person identification information) may be selected (input) instead of an employee, and the customer service data related to that customer displayed in the data display area E12.

Further alternatively, both an employee and a customer could be selected (input) together with an AND or OR condition to display the customer service data matching the result in the data display area E12.

The data display area E12 displays the store, date, employee, customer service number, customer service start and customer service end, relative speaking ratio, overlap count, customer, sale total, and transaction number from each customer service data record.

The customer service number is an identification number automatically assigned to each customer service period, and the customer service period start and end denote the start time and the end time, respectively, of the customer service period.

The relative speaking ratio and overlap count are the relative speaking ratio and overlap count in that customer service period.

The customer field shows the name of the customer that was served.

The sale total and transaction number are the total amount and receipt number of the sales receipt R and are extracted from the converted data.

One customer service data record (row) can be selected at a time in the data display area E12, and the audio data contained in the selected customer service data record can be played back using the controls in the playback control area E13.

The playback control area E13 includes a button group 212 for playing back the audio and video recorded in the customer service period, a progress bar 213 displaying the playback position, and a volume control slider 214. While not shown in the figure, the management server 15 has a playback unit (including an audio output unit such as a speaker) for playing back the audio and video data as controlled in the playback control area E13.

The progress bar 213 includes a time scale with minute marks on the X-axis. The progress bar 213 differentiates employee speech periods, customer speech periods, speech overlap periods, and non-conversation periods not belonging to any of these other periods. These different periods are differentiated in the figure using different shading patterns and white space, but could be differentiated in other ways, such as by color, adding marks or icons, text labels, or any other means enabling the user to distinguish between the different periods. Note that the scale in the progress bar 213 may be in hour units instead of minutes. In addition, the scale units and intervals between the markings could also be changed according to the length of the audio recording so that the total playback time of the recorded audio in the customer service data can be known.

FIG. 25 shows a window D4 for displaying a graph correlating the speaking ratio to sales results. The window D4 includes a display criteria selection area E21 for selecting the search criteria, and a correlation graph display area E22 displaying the correlation between the speaking ratio and sales results (sale information).

The display criteria selection area E21 enables selecting (inputting) a specific store, date range, and employee (person identification information). The employee field also enables selecting ALL to retrieve information for all employees. The correlation graph display area E22 is then compiled and displayed based on the customer service data matching the selected (input) conditions.

The correlation graph display area E22 displays a scatterplot with the customer speaking ratio (unit: %) on the x-axis and the average sale amount per customer (unit: yen) on the y-axis. The intersections between average speaking ratio and sale information (average amount per customer) are plotted in this example based on the customer service data for all customers and all employees on March 5. As a result, the user can easily determine the correlation between an increase in sales and the speaking ratio in the selected store. For example, this graph shows that an increase in sales can be expected when the customer speaking ratio is approximately 70%.

As described above, by calculating the employee-customer speaking ratio, the customer service support system SY according to the third embodiment of the invention enables collecting this information for use in marketing strategies and customer service training.

Furthermore, because the employee identification information and customer identification information are linked together in the customer service data, the calculated speaking ratio can be associated with a particular customer service event between a particular employee and a particular customer. As a result, customer service training can be appropriately targeted to individual employees. Furthermore, because sale information is related to the customer service data, the correlation between speaking ratio and sales can be collected as marketing data.

Furthermore, by calculating and displaying the speaking ratio in each customer service period in the window D, whether or not each customer service occurrence was a generally desirable customer service event (such as whether the length of employee speech to the length of customer speech ratio is near 2:8) can be determined. In addition, because audio data is linked to the customer service data, the audio data can be used as customer service training material by extracting and replaying audio data related to a desirable speaking ratio. More specifically, the conversational skill level of all employees can be improved by efficiently sharing customer service events by employees with good conversation skills with other employees.

Furthermore, because the speech overlap count is also correlated to the customer service data, whether or not a particular customer service event was desirable can be inferred using both the speaking ratio and overlap count. For example, if the overlap count is high, the customer service instance can be determined to have not been desirable even if the speaking ratio is at a desirable level.

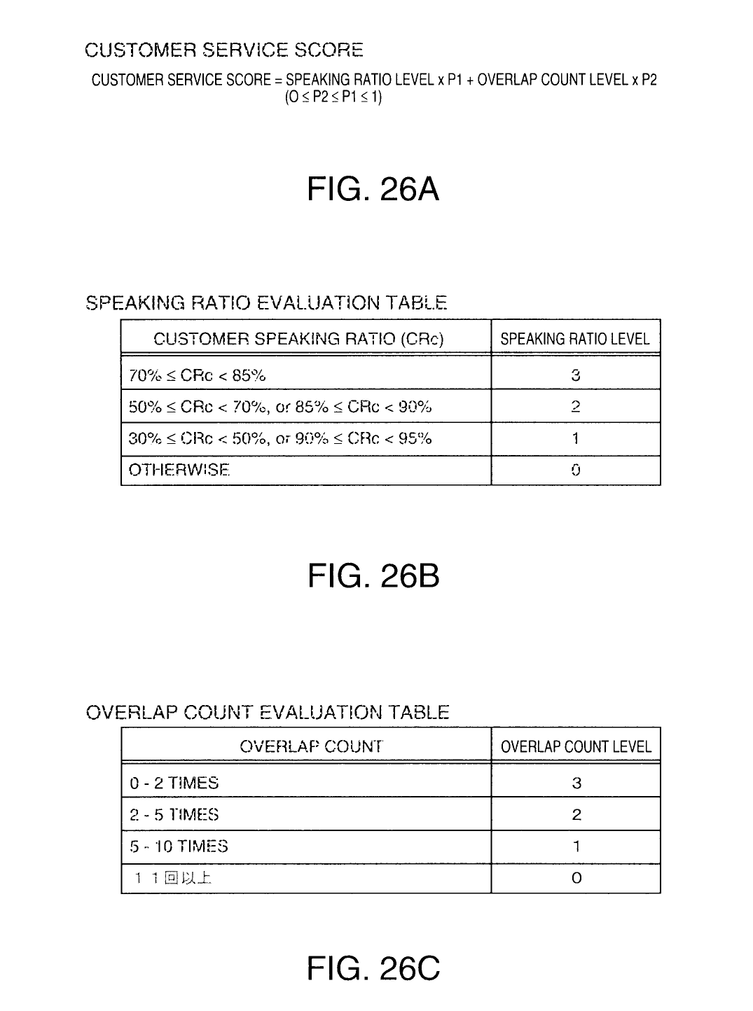

As a variation of the third embodiment, a customer service score based on the speaking ratio and overlap count could be calculated and displayed in the window D. This variation is described next with reference to FIG. 26.

As shown in FIG. 26 (a), the customer service score is calculated using the speaking ratio level and overlap count level as parameters. A weight factor P1 and P2 is respectively applied to the speaking ratio level and overlap count level, and the sum of the weighted values is the customer service score. These weights are generally 0≦P2≦P1≦1, and P1 is greater than P2. More specifically, the customer service score is calculated with the speaking ratio level weighted more heavily than the overlap count level. However, the user can preferably set the weights as desired according to the conditions of the particular store.

The closer the employee-customer speaking ratio is to 2:8, the higher the speaking ratio level. As shown in FIG. 26 (b), the speaking ratio level is a value from 0 to 3 depending upon the customer speaking ratio.

The lower the overlap count, the higher the overlap count level. As shown in FIG. 26 (c), the overlap count level is a value from 0 to 3 depending upon the overlap count.

Customer service can thus be objectively evaluated by calculating a customer service score. In addition, by recording and displaying the evaluation results and customer service score as part of the customer service data in the window D, the store manager or other manager can quickly check the customer service results.

At the end of each conversation period or the end of the customer service period, the result of determining whether or not a customer service instance was desirable or not and/or the customer service score may be reported to the employee involved. In this case, the management server 15 preferably evaluates the customer service and calculates the customer service score, and reports this information using the earphone (not shown in the figure) worn by the employee by means of the intervening receipt printer 13 and employee terminal 5. This enables the employee to learn while serving a customer whether or not the employee is proving desirable customer service, and can therefore be expected to improve the employee's customer service skills.

A set including customer speech periods before and after an employee speech period (that is, a set of at least two and a maximum three speech periods) is defined as “one conversation period,” but the number of speech periods included in one conversation period does not need to be limited. More specifically, a set of alternating employee and customer speech periods that continue without interruptions exceeding a specified time (interval Y) therebetween may be defined as one conversation period.

The foregoing embodiment describes calculating the employee-customer speaking ratio, but the interpersonal relationship is not so limited. More specifically, the speaking ratio may be calculated for conversations between corporate staff members and their managers, between couples, or between friends, for example.

The embodiment described above calculates the speaking ratio for each conversation period or customer service period, but may calculate the speaking ratio during any specified period of time. For example, the speaking ratio may be calculated based on employee and customer speech during a specified period of 10 minutes, for example. Further alternatively, the speaking ratio may be calculated for the entire time an employee works in one day.

The speaking ratio is calculated for each conversation period or customer service period in the foregoing embodiment, but the speaking ratio may be simply calculated based on any adjacent employee and customer speech periods (based on the ratio between the two speech periods).

The person identification unit 352 in the foregoing embodiment recognizes customers using facial recognition technology, but other methods may be used instead. For example, customers could carry a member card with an embedded RFID chip that is then read by an RFID reader located at the store entrance to acquire customer identification information and thereby identify the customer. Employees could also be required to carry an employee card with an embedded RFID chip, enabling an employee to be identified by reading the employee card. This enables determining that an employee is serving a customer and linking the employee to the customer when an employee card and customer card are read at the same time.

Further alternatively, customers could be identified by reading a member card in which magnetic information is recorded (a magnetic stripe card) using a magnetic card reader connected to the POS terminal 12. The customer and employee could then be linked by also having the employee that is serving the customer read the employee card at the same time. Note that the magnetic card reader could be directly connected to the management server 15.

Voice recognition technology could also be used instead of facial recognition technology. In this case the customer information storage unit 81 and employee information storage unit 82 must store voice prints instead of facial feature information.

Images captured by the store camera 11 are sent through a wired LAN to the management server 15 in the foregoing embodiments, but could be sent through the receipt printer 13 to the management server 15. Conversely, the employee terminal 5 is built to send speech data through the receipt printer 13 to the management server 15, but the employee terminal 5 could transmit directly to the management server 15. Functions of the management server 15 could also be rendered by the POS system or an Internet server.

### Embodiment 4

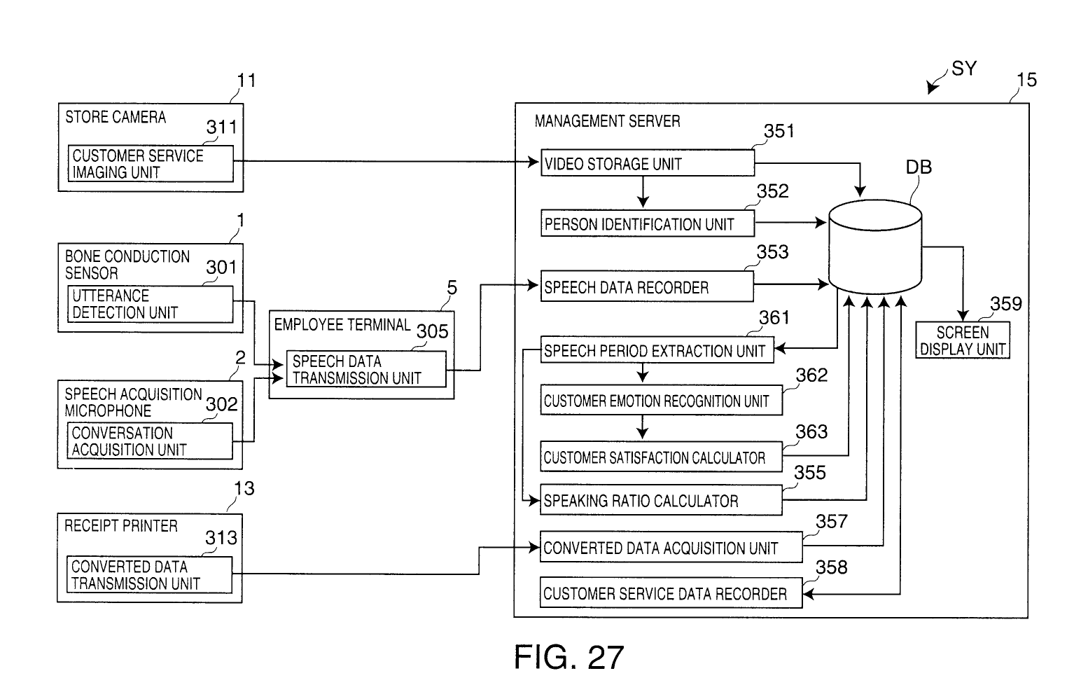

A customer service support system SY according to a fourth embodiment of the invention is described next with reference to FIG. 27 to FIG. 31. The customer service support system SY according to the fourth embodiment of the invention records and uses customer service data correlating speaking ratio data and satisfaction data as marketing data. Only the differences between this and the third embodiment are described below.

FIG. 27 is a function block diagram of a customer service support system SY according to the fourth embodiment of the invention. The management server 15 according to this embodiment of the invention differs from the management server 15 in the third embodiment by the addition of a speech period extraction unit 361, customer emotion recognition unit 362, and customer satisfaction calculator 363.

The speech period extraction unit 361 is equivalent to the speech extraction unit 354 in the third embodiment, and extracts employee speech periods and customer speech periods from the acquired conversations (speech data).

The customer emotion recognition unit 362 recognizes emotion in the customer speech periods extracted from the audio data (the audio data from the customer service period) based on such factors as change in vocal strength, the speed of speech (the number of mora per unit time), the strength of individual words, volume, and change in the speech spectrum. More specifically, emotion recognition is applied to each customer utterance period contained in the audio data. Accurate emotion data can thus be acquired by applying emotion recognition phrase by phrase.

In addition, as shown in FIG. 23, the customer emotion recognition unit 362 also identifies overlap periods where the customer speech period and employee speech period overlap on the time axis, treats such overlap periods as “not emotion recognition periods,” and applies emotion recognition to the customer speech period not including these overlap periods. Recognition errors can thus be prevented by applying emotion recognition except in the overlap periods where customer speech and employee speech is mixed and accurate emotion recognition is not possible.

Based on the recognition results from the customer emotion recognition unit 362, customer satisfaction calculator 363 calculates customer satisfaction. In conjunction with the customer emotion recognition unit 362 applying emotion recognition to each utterance period, customer satisfaction calculator 363 also calculates customer satisfaction in each utterance period.

The customer service data recorder 358 in this embodiment of the invention relates and records the speaking ratio data based on the speaking ratios calculated by the speaking ratio calculator 355, and the satisfaction data based on customer satisfaction calculated by customer satisfaction calculator 363 as part of the customer service data in the management server database DB.

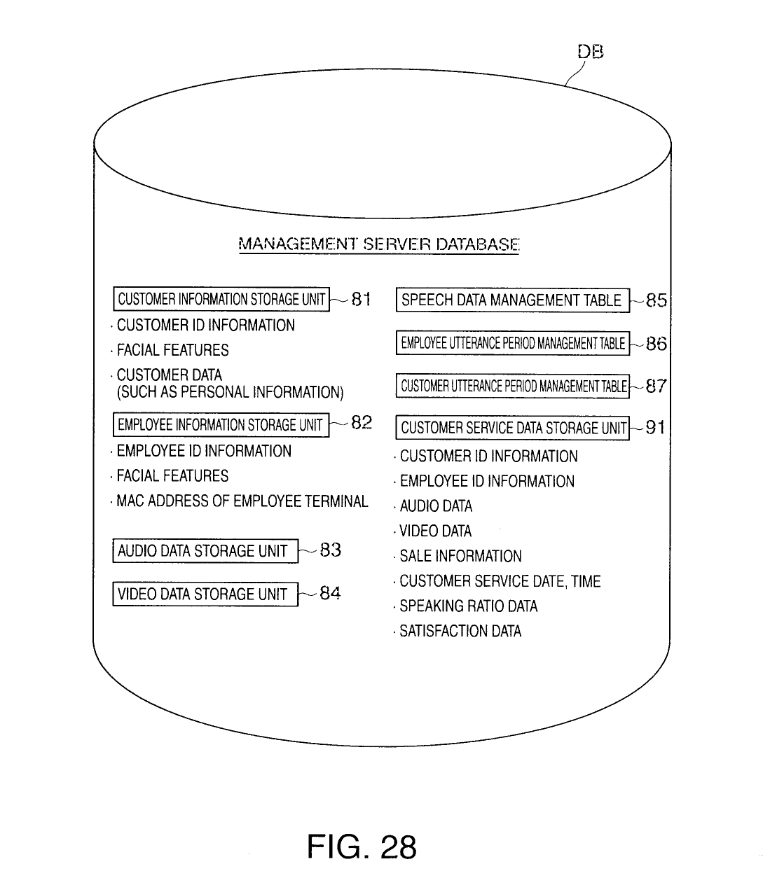

FIG. 28 describes the management server database DB according to the fourth embodiment of the invention. The content of the customer service data storage unit 91 in this management server database DB is different from in the third embodiment. In addition to customer identification information, employee identification information, audio data, video data, sale information, customer service date and time information, the customer service data storage unit 91 in this embodiment of the invention stores also stores speaking ratio data based on the output from the speaking ratio calculator 355, and satisfaction data based on the output from customer satisfaction calculator 363.

The speaking ratio data denotes the speaking ratio in the customer service period and the speaking ratio in the conversation period. The satisfaction data denotes customer satisfaction in the customer service period and customer satisfaction in each conversation period.

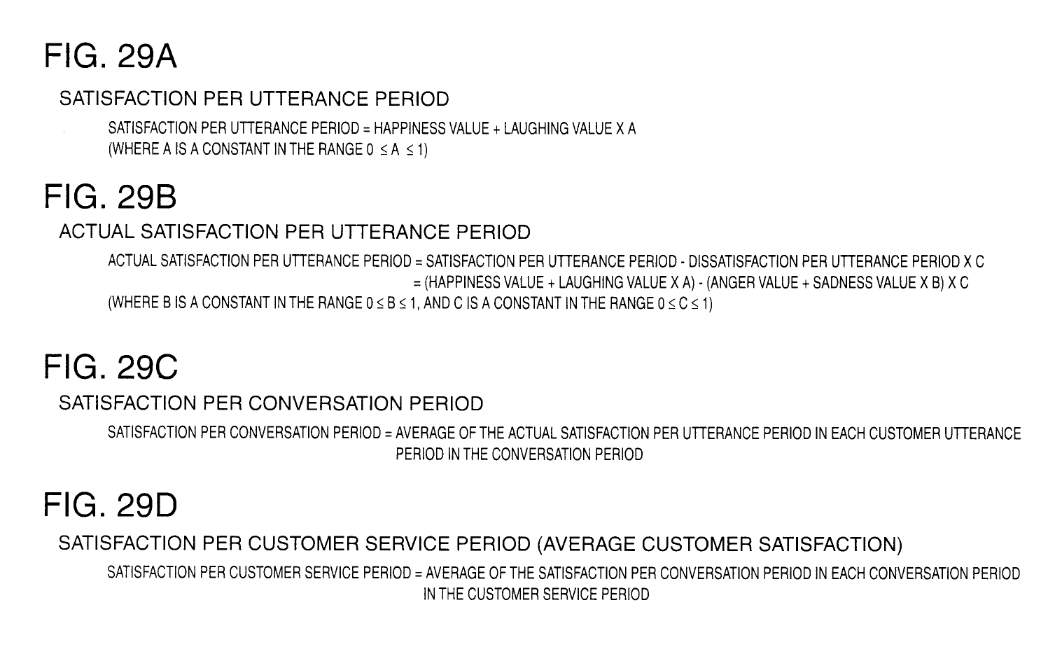

The algorithm (equation) for calculating customer satisfaction is described next with reference to FIG. 29.

As shown in the figure, customer satisfaction is calculated in the following order: utterance period, conversation period, customer service period.

As shown in FIG. 29 (a), the satisfaction in each utterance period is calculated using the equation:

satisfaction per utterance period=happiness value+laughing value×A

where the happiness value is the emotion value for happiness (emotion values ranging from 0-50, for example), the laughing value is the emotion value for laughing, and A is a constant in the range 0≦A≦1.

Note that this algorithm is derived from the concept that a person's level of satisfaction is based on the product of the person's mental state of “comfort” and mental strength.

As shown in FIG. 29 (b), the actual satisfaction per utterance period is calculated from the following equation.

actual satisfaction per utterance period=satisfaction per utterance period−dissatisfaction per utterance period×C

This may be restated as

actual satisfaction per utterance period=(happiness value+laughing value×A)−(anger value+sadness value×B)×C

where the anger value is the emotion value for anger, the sadness value is the emotion value for sadness, B is a constant in the range 0≦B≦1, and C is a constant in the range 0≦C≦1.

By using emotion values for anger and sadness in addition to values for happiness and laughing, a more reliable satisfaction that reflects complicated emotions can be calculated.

This algorithm is derived from the concept that a person's level of dissatisfaction is based on the product of the mental state of discomfort and mental strength, and the actual level of satisfaction is based on the mental states of comfort and discomfort.

As shown in FIG. 29 (c), the satisfaction per conversation period is obtained from the following equation.

satisfaction per conversation period=average of the actual satisfaction per utterance period in each customer utterance period in the conversation period

As shown in FIG. 29 (d), the satisfaction per customer service period is obtained from the following equation.

satisfaction per customer service period=average of the satisfaction per conversation period in each conversation period in the customer service period

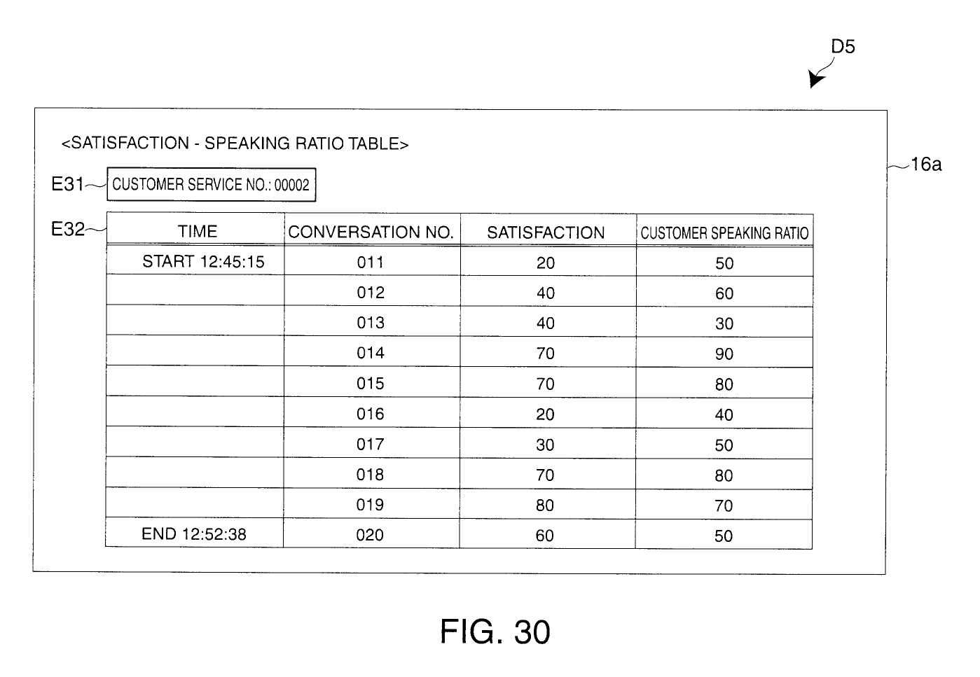

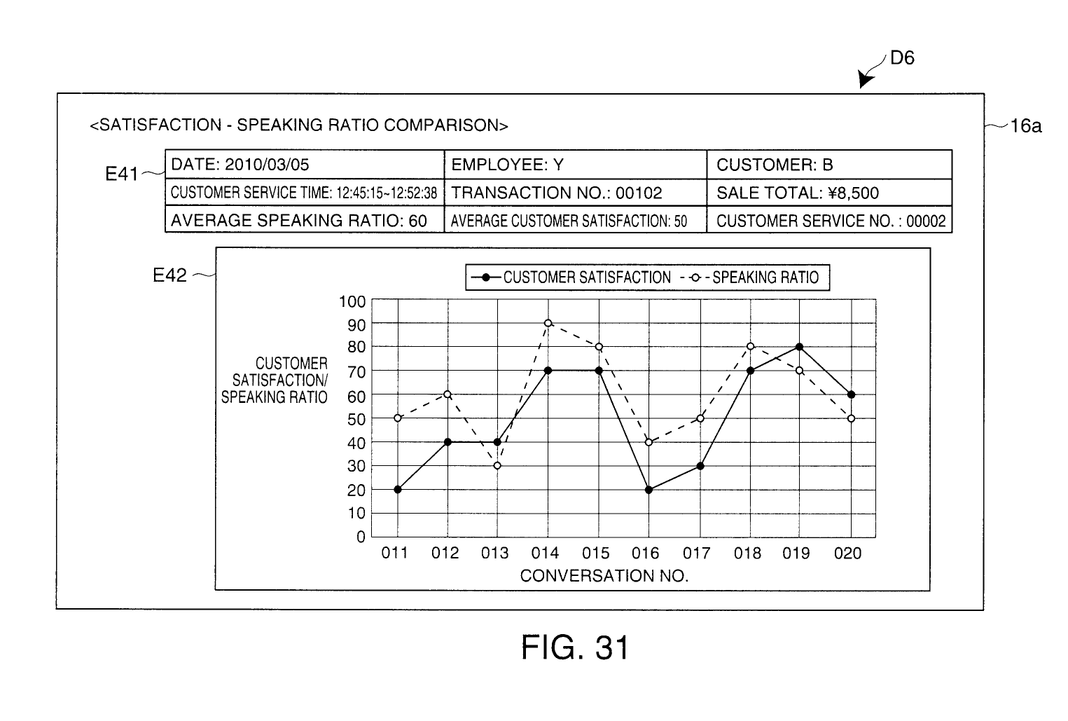

The window D according to the fourth embodiment of the invention is described next with reference to FIG. 30 and FIG. 31. FIG. 30 shows the window D5 for viewing the satisfaction-speaking ratio table. This window D5 is displayed when a button (not shown) for displaying the satisfaction-speaking ratio table is pressed in the window D3 in FIG. 24. The window D5 includes a customer service number display area E31 displaying the number of the customer service period, and a table display area E32 displaying a table of customer satisfaction and customer speaking ratio values. In addition to the start and end times of the customer service period, the table display area E32 displays the conversation number of each conversation period in the customer service period, customer satisfaction in each conversation period, and the customer speaking ratio in each conversation period. Note that the customer satisfaction in each conversation period in this table is the satisfaction per conversation period value shown in FIG. 29 (c).

FIG. 31 shows a window D6 for viewing an overlay graph of satisfaction and speaking ratio values. This window D6 is displayed by operating a button for displaying a satisfaction-speaking ratio overlay graph from the window D3 or D5 shown in FIG. 24 or FIG. 30, for example, and includes a customer service data display area E41 for displaying some of the invention included in the customer service data, and a graph display area E42 for displaying a graph showing the relationship between customer satisfaction and the speaking ratio.

The customer service data display area E41 displays the date, employee, customer, customer service time, transaction number, sale total, average customer speaking ratio, average customer satisfaction, and customer service number. The customer service time shows the customer service start time and end time. The average customer satisfaction is the satisfaction per customer service period shown in FIG. 29 (d).

The graph display area E42 displays a first broken line (solid line with solid dots at data points) with the conversation number on the x-axis and customer satisfaction on the y-axis overlaid with a second broken line (dotted line with open circles at data points) having the conversation number on the x-axis and the speaking ratio on the y-axis. The conversation numbers on the x-axis are arranged in chronological order. Note that time (time of day) could be plotted on the x-axis instead of the conversation number. The emotion values and constants A, B, C are set so that customer satisfaction is a value from 0 to 100. The speaking ratio denotes the customer speaking ratio as a percentage, and ranges from 0 to 100%. By thus graphing the change in customer satisfaction in each conversation period and the change in the speaking ratio in each conversation period during the customer service period on a common time base, the user can visually ascertain the change in the conversation and the change in customer emotion during a single customer service period, and the correlation therebetween.

As described above, the customer service support system SY according to the fourth embodiment of the invention correlates and records speaking ratio data and satisfaction data as customer service data, and can therefore use the data for marketing purposes. In addition, the effect of the speaking ratio on customer satisfaction can be inferred and the effect of conversation training can be verified from the customer service data.

In addition, change in the conversation and change in customer satisfaction during one customer service event can be checked by recording the speaking ratio in each conversation period as speaking ratio data and recording customer satisfaction in each conversation period as satisfaction data, and displaying this information in the windows D5, D6.

Furthermore, because the average speaking ratio and average customer satisfaction in each customer service period are recorded and displayed as customer service data (see E41 in FIG. 31), customer service can be easily evaluated comprehensively.

The employee-customer speaking ratio and customer satisfaction are calculated for customer service management purposes in the foregoing embodiment, but these values could be used for personal reasons. This enables using the collected speaking ratio data and satisfaction data to improve an individual's interpersonal conversation skills (conversational technique).

### Embodiment 5

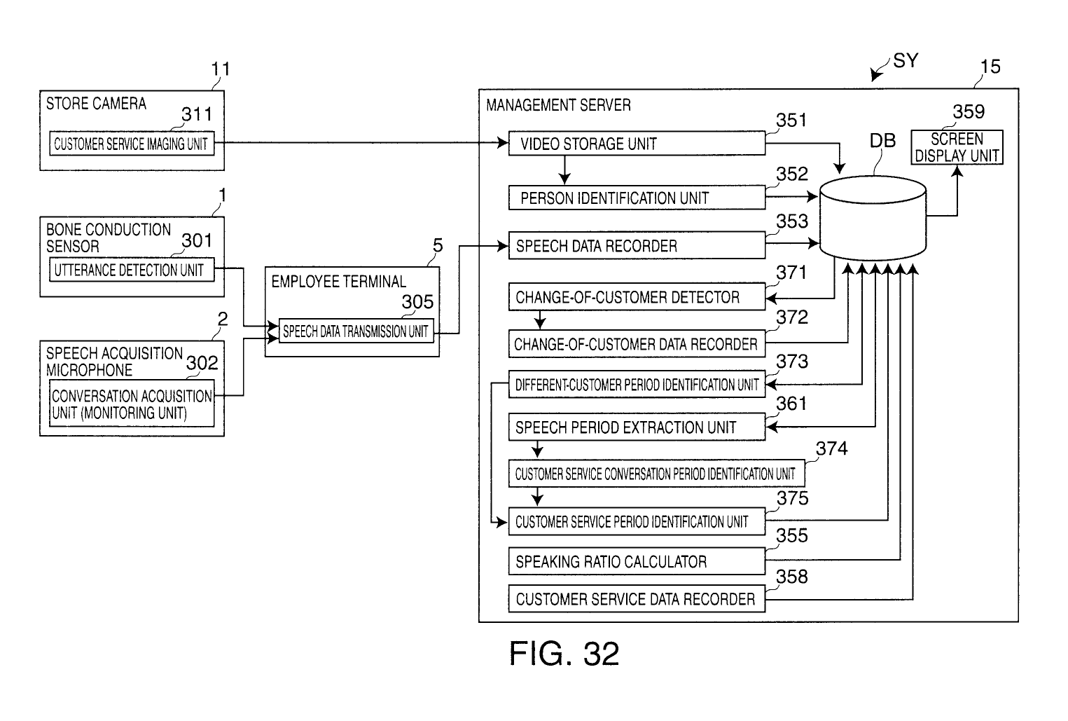

A fifth embodiment of the invention is described next with reference to FIG. to FIG. 32 to FIG. 39.

The customer service support system SY according to the fifth embodiment of the invention identifies the customer service period for each customer that is served based on the results from a surveillance unit that surveils employees and customers. The differences between this and the third and fourth embodiments are described below.

FIG. 32 is a function block diagram of a customer service support system SY according to the fifth embodiment of the invention. In this embodiment of the invention the speech acquisition microphone 2 functions as a monitoring unit. More specifically, the monitoring unit includes a conversation acquisition unit 302 (described below in another example of a monitoring unit). The conversation acquisition unit 302 captures conversations between an employee and customers.

The management server 15 in this embodiment of the invention differs from that in the fourth embodiment by the addition of a change-of-customer detector 371, change-of-customer data recorder 372, change-of-customer data recorder 372, different customer period identification unit 373, customer service conversation period identification unit 374, and customer service period identification unit 375.

Based on the output from the monitoring unit, or more specifically customer speech contained in the conversation acquired by the conversation acquisition unit 302, the change-of-customer detector 371 detects a change in the customer that the employee is serving. This embodiment of the invention regularly applies voiceprint verification to customer speech and detects when the customer changes from the result of voiceprint verification. Note that a speech characteristic other than a voice print (such as the pitch or speed of speech) could be determined from the customer speech, and when the customer changes could be detected from change in this characteristic.

The change-of-customer data recorder 372 relates and stores the employee identification information identifying the employee and the detection time (time stamp) of the change-of-customer detector 371 as change detection data in the management server database DB.

Based on the recorded change detection data, the different-customer period identification unit 373 identifies each different-customer period using detection time N (where N is an integer N·1) from the start of detection as the time the period starts, and detection time N+1 as the end time of the period. The different-customer period is thus a period that is identified from the change detection data.

Based on the speech period extracted by the speech period extraction unit 361, the customer service conversation period identification unit 374 identifies the customer service conversation period. Note that the customer service period in the third and fourth embodiments is equivalent to the customer service conversation period. As described above, a conversation period is a set of speech periods in which employee and customer speech periods alternately repeat without interruptions exceeding a specified time therebetween, and one customer service conversation period is identified as a set of consecutive conversation periods that continue without an interruption exceeding a specified time. More specifically, the customer service conversation periods are identified based on audio data contained in the customer service data.

The customer service period identification unit 375 identifies the customer service period based on the different-customer period identified by the different-customer period identification unit 373, and the customer service conversation period identified by the customer service conversation period identification unit 374. More specifically, the customer service period is identified by applying an AND or OR operation to the customer service conversation period and different-customer period. The customer service period identification unit 375 links and compares selected change detection data and audio data by means of the employee identification information. The customer service period identification method of the customer service period identification unit 375 is described below.

The speaking ratio calculator 355 in this embodiment of the invention thus calculates the speaking ratio in the customer service period that was identified by the customer service period identification unit 375.

The customer service data recorder 358 records audio data, which is the speech data from the customer service period identified by the customer service period identification unit 375, and video data, which is the image data from the customer service period identified by the customer service period identification unit 375, as customer service data.

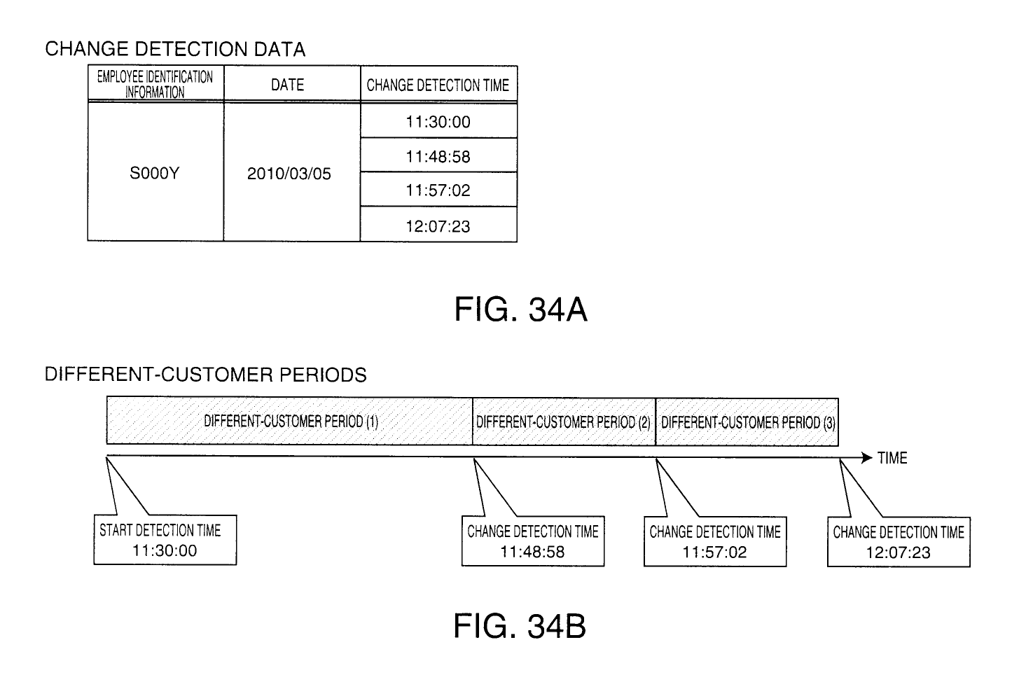

In response to user commands, the screen display unit 359 in this embodiment of the invention displays the different-customer period identified by the different-customer period identification unit 373, the customer service conversation period identified by the customer service conversation period identification unit 374, and the customer service period identified by the customer service period identification unit 375, in a viewing window D (such as shown in FIG. 34 to FIG. 38, for example). Controls (not shown in the figure) are also provided in the window D so that the user can adjust the start time and end time of the customer service period.

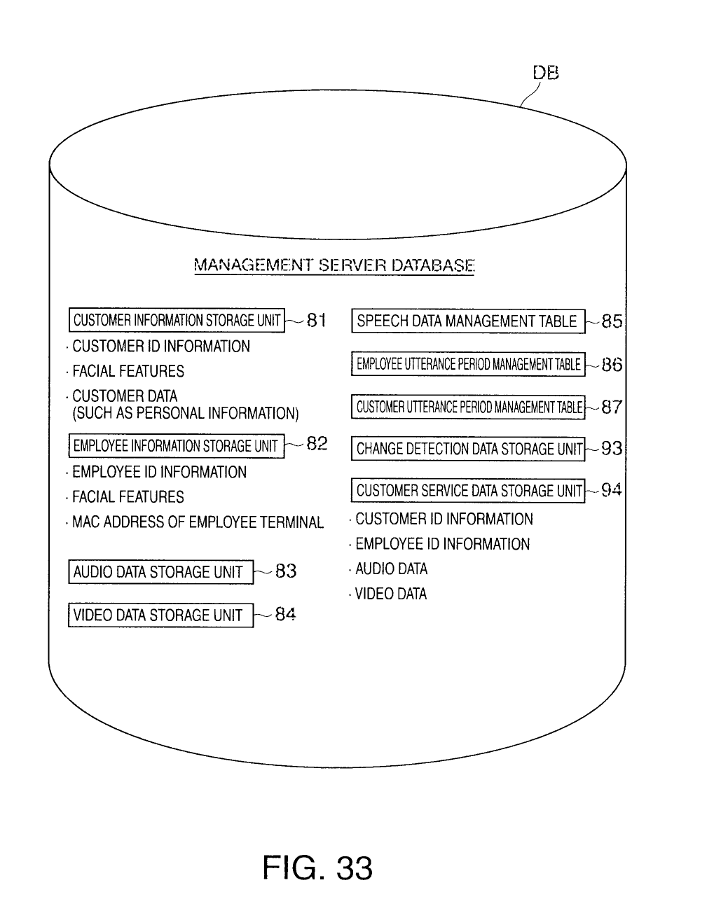

FIG. 33 describes a management server database DB according to the fifth embodiment of the invention. In addition to the functions of the third embodiment and fourth embodiment, the management server database DB in this embodiment of the invention also functions as a change detection data storage unit 93.

The change detection data storage unit 93 stores the change detection data recorded by the change-of-customer data recorder 372.

The customer service data storage unit 94 in this embodiment of the invention also stores customer service period data in addition to customer identification information, employee identification information, audio data equivalent to the speech data in the customer service period, video data equivalent to the video data in the customer service period, and the speaking ratio in the customer service period. The customer service period data denotes the start time and the end time of the customer service period.

The change detection data and different-customer periods are described next with reference to FIG. 34. As shown in FIG. 34 (a), is information linking employee identification information, the date, and the change detection time. The change detection time is the time the change-of-customer detector 371 detected that the customer changed. This embodiment of the invention regularly applies voiceprint verification to customer speech and detects when the customer changes from the result of voiceprint verification (that is, when the voice print of a different customer is recognized).

FIG. 34 (b) schematically describes different-customer periods on the time base. Because a new different-customer period is defined as starting every time a change of customer is detected, the different-customer periods run continuously with no gap between adjacent periods.

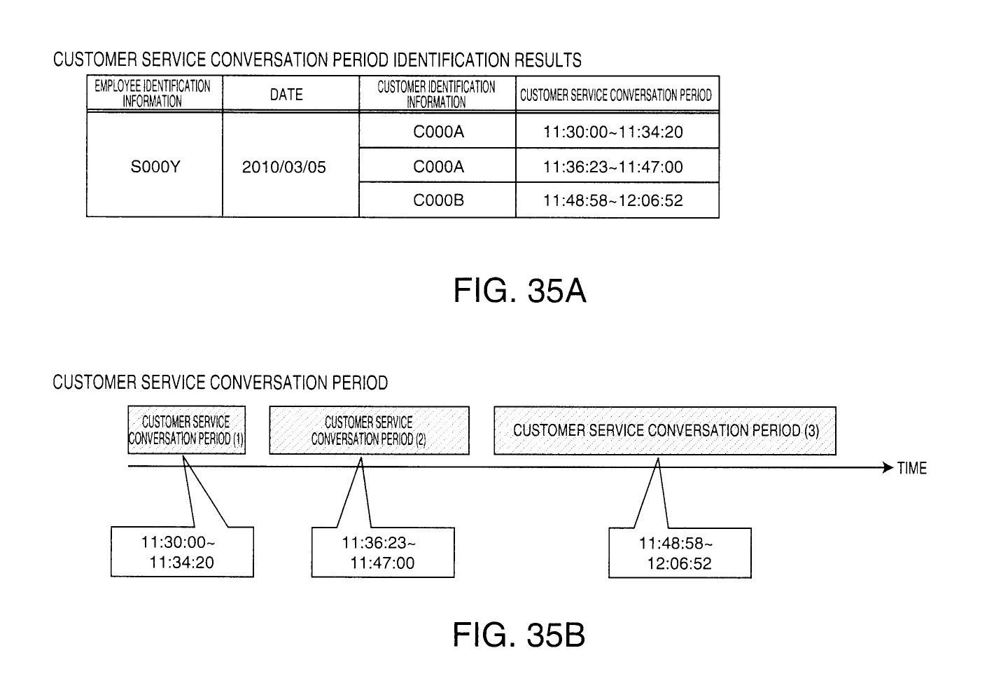

The customer service conversation periods are described next with reference to FIG. 35. FIG. 35 (a) shows the results of customer service conversation period identification. The customer service conversation periods are identified using the method for identifying customer service periods described above in the third embodiment. This figure shows the resulting employee identification information, date, customer identification information, and customer service conversation periods. The standard length of the interval between customer service conversation periods (interval Z in FIG. 5 (b)) is 1 minute 30 seconds.

FIG. 35 (b) schematically describes customer service conversation periods on the time base. Because a customer service conversation period is defined as a set of consecutive conversation periods that continue without interruptions exceeding a specified time therebetween, gaps occur between adjacent periods as shown in the figure.

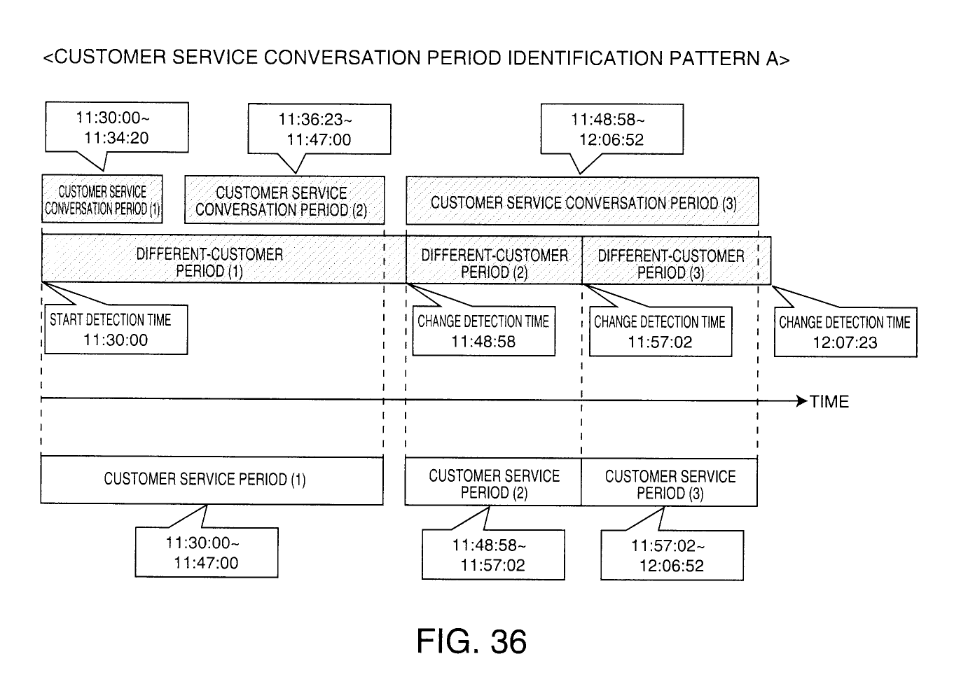

The method of identifying customer service periods is described next with reference to FIG. 36 to FIG. 38. This embodiment of the invention uses three patterns (customer service period identification patterns A to C) to identify customer service periods. FIG. 36 shows customer service period identification pattern A. Customer service period identification pattern A identifies the customer service period based on customer service conversation periods. However, when plural consecutive customer service conversation periods are included in one different-customer period (the relationship between customer service conversation periods (1) and (2) and different-customer period (1)), the time from the start to the end time of the plural customer service conversation periods is identified as one customer service period (customer service period (1)).

In addition, if a different-customer period is interrupted during a customer service conversation period (the relationship between customer service conversation period (3) and different-customer period (2) and (3)), the customer service period is segmented at the time the different-customer period was interrupted. More specifically, in this example, the period from the start time of customer service conversation period (3) to the end time of the different-customer period (2) becomes customer service period (2), and the period from the end time of different-customer period (2) (the start time of customer service conversation period (3)) to the end time of customer service conversation period (3) becomes customer service period (3).

If the length of a customer service period identified by this identification method is less than a specific time, that period is preferably ignored and not identified as a customer service period.

In a system that detects from change in the voice print of the customer when the customer changes, customer service period identification pattern A in this embodiment of the invention enables accurately identifying customer service periods customer by customer. More particularly, if the customer service period is identified only from the different-customer periods (that is, different-customer period=customer service period), identification errors can result when, for example, the customer has already changed but the new customer has not said anything, resulting in falsely determining that the same customer service period still continues. For example, in a situation where customer service conversation period (2) is not in different-customer period (1), the time occupied by customer service conversation period (2) will be added to customer service conversation period (1). Therefore, by identifying the customer service period based on the customer service conversation periods, errors in the customer service period end time can be eliminated.

In addition, if the customer service periods are identified using only the customer service conversation periods (customer service conversation period=customer service period), a different customer service period may be falsely detected as a result of the conversation being interrupted for longer than a specified time even though the customer has not changed (the relationship between customer service conversation periods (1) and (2) and different-customer period (1), for example). Similarly, the same customer service period may be falsely determined to continue even though the customer changed because the interruption in the conversation did not last for at least the specified time (the relationship between customer service conversation period (3) and different-customer periods (2) and (3), for example).

Customer service periods can thus be accurately identified by comparing both customer service conversation periods and different-customer periods to identify the customer service periods instead of using only customer service conversation periods or only different-customer periods.

The change-of-customer detector 371 in this embodiment of the invention regularly applies voiceprint verification and determines that the customer being served changed when the result of voiceprint verification changes, but could instead determine that the customer changed if the incidence of the same voice print within a specified time goes below a specified threshold.

Because the customer being served is not necessarily alone, such as when accompanied by family members, this configuration enables accurately detecting the customer service periods of individual customers by detecting a change of customer based on the incidence of the same voice print within a specified time. For example, it could be determined that the customer did not change if the voice print of the same person is recognized one or more times in one minute.

Note that instead of detecting a change of customer based on the incidence of the same voice print in a specified time, a change of customer could also be detected if the same voice print is not detected for at least a specified time.

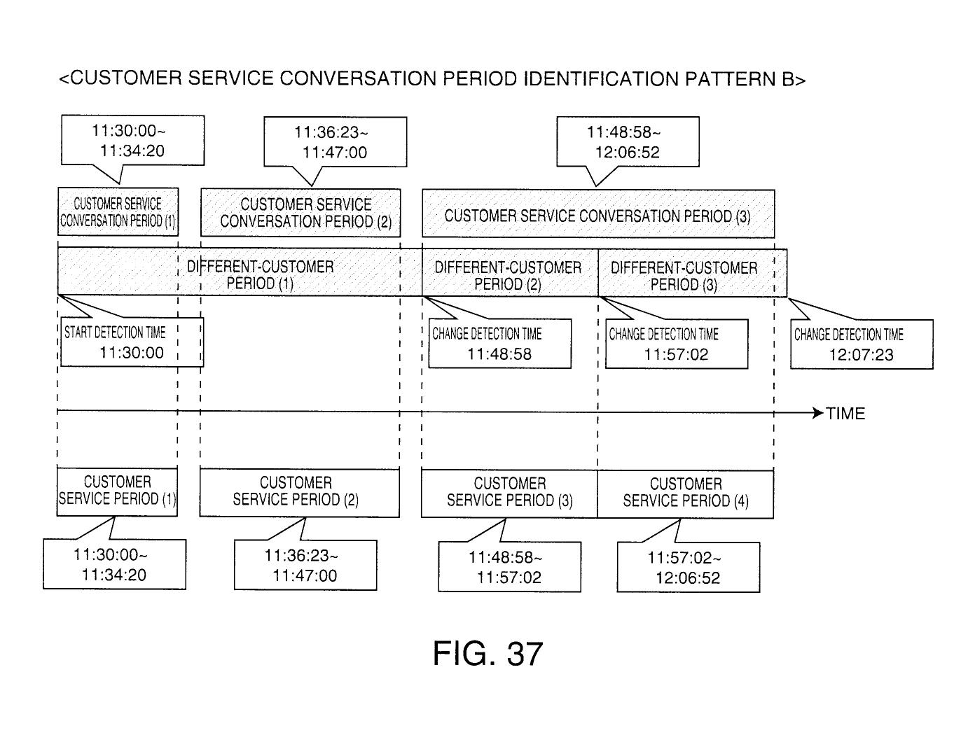

Referring next to FIG. 37, customer service period identification pattern B is described next. Customer service period identification pattern B identifies customer service periods by extracting periods where the customer service conversation period and different-customer period overlap (an AND operation). For example, because customer service periods (1) and (2) are both periods in different-customer period (1), they are the same as customer service conversation periods (1) and (2). In addition, because different-customer period (2) is a period in customer service conversation period (3), different-customer period (2) is customer service period (3). In addition, customer service conversation period (3) and different-customer period (3) are compared to extract the period where they overlap, and this overlapping period becomes customer service period (4).

Note that customer service periods shorter than a specified time are preferably not identified.

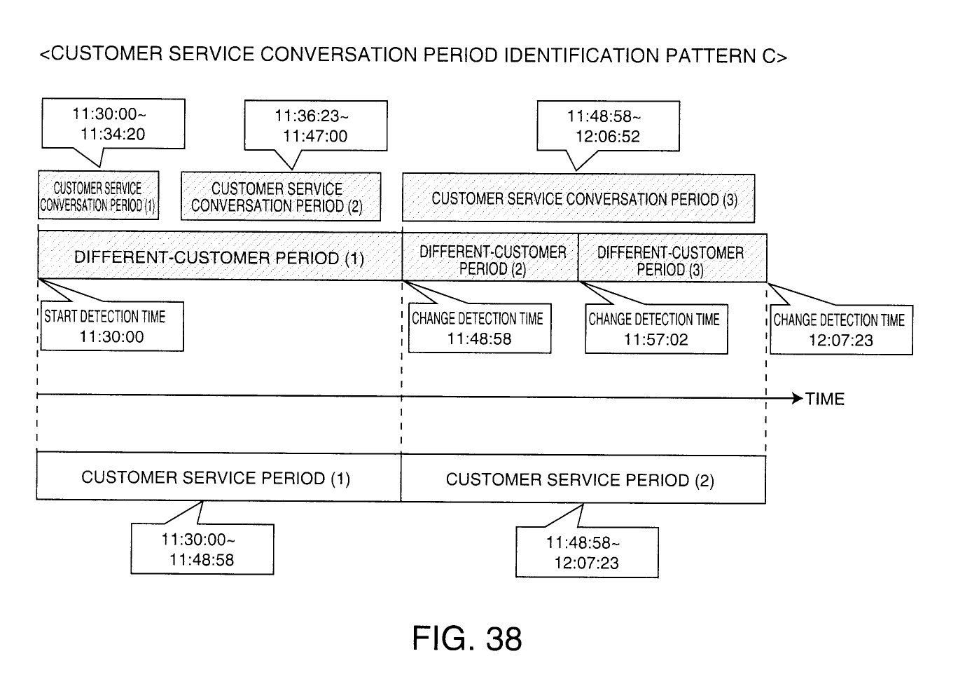

Customer service period identification pattern C is described next with reference to FIG. 38. Customer service period identification pattern C identifies customer service periods based on different-customer periods. For example, customer service period (1) is the same as different-customer period (1).

However, if the customer service conversation period is longer than the different-customer period (the relationship between customer service conversation period (3) and different-customer period (2)), the end time of the different-customer period is not used as the time that the customer service period changed. More specifically, the combined period of different-customer periods (2) and (3) becomes customer service period (2) (the start time of customer service period (2) is the start time of different-customer period (2), and the end time of customer service period (2) is the end time of different-customer period (3)).

Note that customer service periods shorter than a specified time are also preferably not identified in this example.

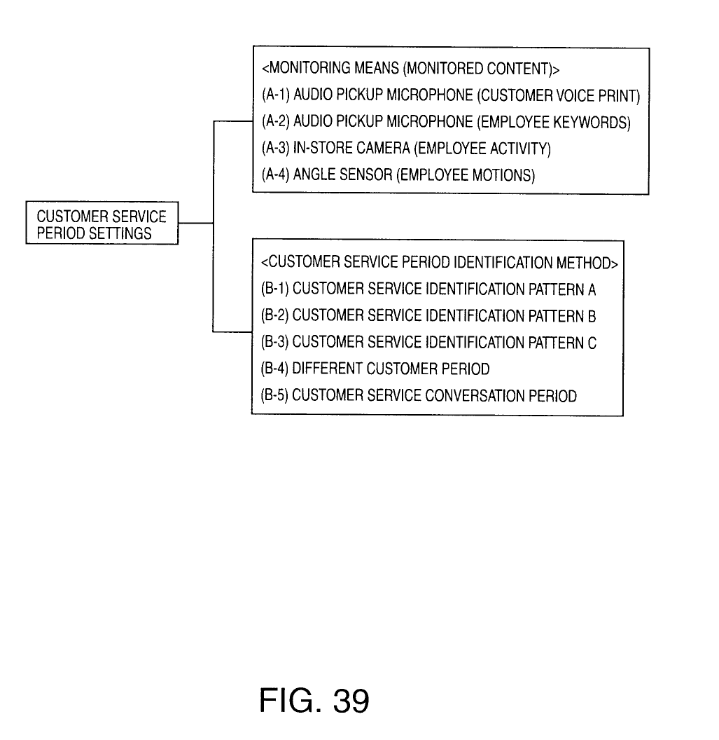

Customer service period settings (a variation of this embodiment) are described next with reference to FIG. 39. In this embodiment of the invention the monitoring means is a speech acquisition microphone 2, and the customer is determined to have changed when a change in the customer voice print is detected. More specifically, (a-1) in the figure is used as the monitoring means (monitored content). In this case, customer service period identification pattern A is preferably used for customer service period identification ((b-1) in the figure), but a different identification pattern may be used. More specifically, customer service period identification pattern B ((b-2) in the figure) or customer service period identification pattern C ((b-3)) could be used. Other methods of identifying the customer service period include defining the different-customer period as the customer service period (b-4), or defining the customer service conversation period as the customer service period (b-5).

As shown in (a-2) in the figure, keywords spoken by the employee may be monitored. In this case, the change-of-customer detector 371 applies speech recognition to employee speech, and determines that the customer changed when specific words are recognized.

In this configuration the management server 15 must have a speech recognition unit including an audio analyzer, audio model, language model, word dictionary, and text conversion unit. The speech recognition unit preferably recognizes employee speech contained in the recorded audio by utterance period unit. This configuration enables easily detecting a change of customer by detecting specific keywords.

For example, the time that “Welcome!”, which is a keyword indicating the start of a customer service period, is detected could be used as the change detection time. In addition, the time that a phrase such as “please come again,” “thank you,” or “please wait a moment”, which are used as keywords denoting the end of a customer service period, is detected may also be used as the change detection time. Keywords to be spoken when finishing serving a customer could also be predefined for an individual store, and the time that the keyword is detected could be used as the change detection time. In this case words that are not normally used when serving a customer, such as “the end” or “goodbye”, are preferably used as the keyword.

Furthermore, a change of customer can be detected more accurately by detecting both starting keywords denoting the start of a customer service period and ending keywords denoting the end of a customer service period. For example, the start of a different-customer period could be determined by detecting the keyword “welcome,” and the end of the different-customer period could be determined by detecting the keyword “please come again.”

Unlike the examples described above, this configuration results in a gap between adjacent different-customer periods.

As shown in (a-3) in FIG. 39, the store camera 11 may be used as the monitoring means to monitor employee activity.

In this case, the customer service imaging unit 311 that records the customer service events between an employee and customer functions as the monitoring unit, and the change-of-customer detector 371 detects when the customer changes based on the images captured by the customer service imaging unit 311. More specifically, the employee is identified by recognizing images in the video, and a change of customer is detected when specific employee actions are detected.

The store camera 11 may be installed on the ceiling or countertop, or a small camera could be attached to the employee's clothing or body instead of using the store camera 11.

The specific activities could include normal behavior such as bowing to a customer when finishing serving the customer, in which case the time that bowing is detected is used as the change detection time. Specific actions (motions) performed when finishing serving a customer could also be defined for a particular store, and a change of customer detected when that action is detected. These actions are preferably actions that are not normally used when serving a customer, such as facing the camera and signaling the peace (V) sign or moving to a specific location.

Yet further, a change of customer can be detected more accurately by detecting both starting actions denoting the start of a customer service period and ending actions denoting the end of a customer service period. For example, the start of a different-customer period could be determined by detecting the action of facing the camera and signaling the peace (V) sign, and the end of the different-customer period could be determined by detecting the employee bowing to the customer.

This configuration also results in a gap between adjacent different-customer periods.

As shown in (a-4) in FIG. 39, an angle sensor (not shown in the figures) could be used as the monitoring means to monitor employee actions. In this case, an action detection unit (not shown in the figures) that detects employee actions functions as the monitoring unit, and the change-of-customer detector 371 detects a change of customer based on the output from the action detection unit. Note that the action detection unit is preferably worn on the upper body of the employee. A gravity sensor or gyroscopic sensor could be used instead of an angle sensor.

The action detection unit preferably outputs to the employee terminal 5, and the employee terminal 5 sends the detection result to the management server 15. In this case the change-of-customer detector 371 detects a change of customer as a result of the action detection unit detecting the upper body of the employee tilting forward. This configuration can detect the employee bowing at the end of the customer service period from the tilting motion of the employee's upper body, and by detecting this motion can accurately detect a change of customer.

In addition to such natural motions, specific actions performed at the end of serving a customer could be predefined for a particular store, and a change of customer can be detected by detecting these motion. Examples of such motions include touching the employee card, tapping a pocket, or other motion that is not normally used when serving a customer.

A contact sensor, infrared sensor, or other type of sensor may also be used as the action detection unit. A particular operating means, such as button that is operated by the employee, could also be used as the action detection unit instead of a sensor.

Yet further, a change of customer can be detected more accurately by detecting both starting actions denoting the start of a customer service period and ending actions denoting the end of a customer service period. For example, the start of a different-customer period could be determined by detecting the action of touching the employee card, and the end of the different-customer period could be determined by detecting the employee bowing to the customer.

This configuration also results in a gap between adjacent different-customer periods.

This embodiment of the invention thus enables the user to select the desired monitoring means and customer service period identification method from among a plurality of choices using the input device 55 of the management server 15, for example. The monitoring means and customer service period identification method can also be combined as desired and changed according to the installation and user needs.

As described above, the customer service support system SY according to the fifth embodiment of the invention detects a change in the customer being served based on the results of monitoring either or both the employee and customer, relates and records the time of detection and the employee identification information as change detection data, and can therefore identify different-customer periods from the change detection data. Furthermore, because the change detection data is recorded, it can also be tabulated as marketing data and used to improve the customer service skills of the employees.

Furthermore, because the different-customer period identified from the change detection data and the customer service conversation period identified from the recorded audio are compared to identify the customer service periods, customer service periods in which the employee serves different customers can be accurately identified. A reliable speaking ratio can also be calculated by accurately identifying the customer service periods.

In addition, because the calculated speaking ratio is recorded as part of the customer service data, the customer service data can be used in educational materials for teaching customer service techniques, and to determine the customer service quality (customer service data). As a result, customer service techniques that are considered to be good based on the speaking ratio can be shown to other employees to help improve the customer service skills of all employees.

The embodiment described above calculates the speaking ratio in the customer service period identified by the customer service period identification unit 375, but customer satisfaction during the customer service period could be calculated, and the speaking ratio data and satisfaction data could be correlated and stored as customer service data. More specifically, the fourth embodiment and fifth embodiment could be combined.

The processes of the customer service support systems SY described in the first to fifth embodiments above can also be rendered as a computer-executable program. The program can be provided stored on a recording medium such as CD-ROM disc or flash memory, for example. More specifically, a program that causes a computer to function as the functional elements of the customer service support system SY, and a recording medium storing this program, are also included in the scope of the accompanying claims. The configuration of the customer service support system SY and process steps, including combining different aspects of the foregoing embodiments, are also not specifically limited and can be varied in many ways without departing from the scope of the accompanying claims.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A customer service data recording device comprising:
a conversation acquisition unit that acquires employee and customer conversations;
an emotion recognition unit that recognizes employee and customer emotions based on employee and customer speech contained in the conversation;
a satisfaction calculation unit that calculates employee satisfaction and customer satisfaction based on emotion recognition by the emotion recognition unit; and
a customer service data recording unit that relates and records employee satisfaction data denoting employee satisfaction and customer satisfaction data denoting customer satisfaction as first customer service data in a database.

2. The customer service data recording unit described in claim 1, further comprising:
a customer service period identification unit that identifies customer service periods where one customer service period is defined as a conversation between an employee and a customer that continues without an interruption exceeding a specified time;
wherein the customer service data recording unit records employee satisfaction data and customer satisfaction data for each customer service period.

3. The customer service data recording unit described in claim 2, wherein:
the customer service data recording unit stores either or both the start time and the end time of the customer service period together with the employee satisfaction data and the customer satisfaction data.

4. The customer service data recording unit described in claim 1, further comprising:
an identification unit that identifies employees and customers;
wherein the customer service data recording unit records employee identification information identifying the employee and customer identification information identifying the customer related to the employee satisfaction data and the customer satisfaction data.

5. The customer service data recording unit described in claim 1, wherein:
the customer service data recording unit stores sales results indicating the result of customer service provided by the employee to the customer together with the employee satisfaction data and the customer satisfaction data.

6. The customer service data recording unit described in claim 1, wherein:
the customer service data recording unit stores audio data of the recorded conversation and video data of the employee serving the customer together with the employee satisfaction data and the customer satisfaction data.

7. The customer service data recording unit described in claim 6, further comprising:
an audio playback unit that reproduces the audio data;
a progress bar display unit that displays a progress bar indicating the progress of audio playback; and
a speech period identification unit that identifies the speech periods where one speech period is a set of consecutive employee or customer utterance periods that continue without an interruption exceeding a specified time, and one utterance period is a period of continuous vocalization;
wherein the progress bar display unit displays the progress bar to differentiate the employee speech periods and the customer speech periods identified by the speech period identification unit.

8. The customer service data recording unit described in claim 1, further comprising:
a speech period extraction unit that extracts employee speech periods and customer speech periods from the acquired conversation, the employee speech periods being vocalization periods resulting from employee speech and the customer speech periods being vocalization periods resulting from customer speech; and
a speaking ratio calculation unit that calculates a speaking ratio as a ratio of the length of the employee speech period and the length of the customer speech period, or as a ratio of the length of the employee speech period or customer speech period to the total length of the employee speech period and the customer speech period;
wherein the emotion recognition unit recognizes customer emotion based on speech in the customer speech period; and
the customer service data recording unit records speaking ratio data based on the calculated speaking ratio related to satisfaction data based on customer satisfaction as second customer service data in a database.

9. The customer service data recording device described in claim 8, further comprising:
an utterance detection unit that is attached to the employee and detects employee utterances;
wherein based on the detection result from the utterance detection unit, the speech period extraction unit determines if speech contained in the conversation is employee speech or customer speech, and extracts the speech periods based on the result of this determination.

10. The customer service data recording device described in claim 8, wherein:
when a vocalization period that continues without inhaling is one utterance period, and a set of employee or customer utterance periods that continue without an interruption exceeding a specified time is one speech period,
the speaking ratio calculation unit calculates the length of each speech period as the total length of all utterance periods contained in one speech period.

11. The customer service data recording device described in claim 10, wherein:
when a set of employee and customer speech periods that alternate without an interruption exceeding a specified time therebetween is one conversation period,
the speaking ratio calculation unit calculates the speaking ratio in each conversation period based on one or more speech periods contained in the conversation period, and
the satisfaction calculation unit calculates customer satisfaction in each conversation period based on customer satisfaction in each customer speech period in the conversation period.

12. The customer service data recording device described in claim 11, wherein:
the emotion recognition unit applies emotion recognition by utterance period unit; and
the satisfaction calculation unit calculates customer satisfaction by utterance period unit, and calculates customer satisfaction in the customer speech period as the average of customer satisfaction in each utterance period in the customer speech period.

13. The customer service data recording device described in claim 8, further comprising:
a screen display unit that displays a screen for viewing the second customer service data;
wherein the screen display unit extracts and displays on the viewing screen customer service data containing person identification information matching the selected or input person identification information identifying a employee and/or customer.

14. A customer service data recording method that records customer service data in a database based on employee and customer conversations, the recording method comprising as steps executed by a computer:
a conversation acquisition step that acquires employee and customer conversations;
an emotion recognition step that recognizes employee and customer emotions based on employee and customer speech contained in the conversation;
a satisfaction calculation step that calculates employee satisfaction and customer satisfaction based on emotion recognition by the emotion recognition step; and
a customer service data recording step that relates and records employee satisfaction data denoting employee satisfaction and customer satisfaction data denoting customer satisfaction as first customer service data in the database.

15. The customer service data recording method described in claim 14, wherein the computer also executes:
a customer service period identification step that identifies customer service periods where one customer service period is defined as a conversation between an employee and a customer that continues without an interruption exceeding a specified time; and
in the customer service data recording step records employee satisfaction data and customer satisfaction data for each customer service period.

16. The customer service data recording method described in claim 15, wherein:
the customer service data recording step stores either or both the start time and the end time of the customer service period together with the employee satisfaction data and the customer satisfaction data.

17. The customer service data recording method described in claim 14, wherein the computer also executes:
a speech period extraction step that extracts employee speech periods and customer speech periods from the acquired conversation, the employee speech periods being vocalization periods resulting from employee speech and the customer speech periods being vocalization periods resulting from customer speech; and
a speaking ratio calculation step that calculates a speaking ratio as a ratio of the length of the employee speech period and the length of the customer speech period, or as a ratio of the length of the employee speech period or customer speech period to the total length of the employee speech period and the customer speech period; and
in the emotion recognition step recognizes customer emotion based on speech in the customer speech period; and
in the customer service data recording step records speaking ratio data based on the calculated speaking ratio related to satisfaction data based on customer satisfaction as second customer service data in a database.

18. The customer service data recording method described in claim 17, wherein the computer also executes:
an utterance detection step that is attached to the employee and detects employee utterances; and
in the speech period extraction step, determines if speech contained in the conversation is employee speech or customer speech based on the detection result from the utterance detection step, and extracts the speech periods based on the result of this determination.

19. A computer-readable recording medium that stores a program causing a computer to execute the steps of the customer service data recording method described in claim 14.
